(19) United States
(12) Patent Application Publication
(10) Pub. No.: US 2026/0235418 A1
(43) Pub. Date: Aug. 13, 2026

(54) DEVICE-BASED GEOSPATIAL FILTERING FOR BAROMETRIC PRESSURE SENSOR CALIBRATION

(71) Applicant: NextNav, LLC, Santa Clara, CA (US)

(72) Inventors: Deepak JOSEPH, Oakton, VA (US); Michael DORMODY, San Jose, CA (US); Badrinath NAGARAJAN, Cupertino, CA (US); Brandon Zhang, Cupertino, CA (US); Jean Zhou, Cupertino, CA (US); Frank YENSHAW, San Mateo, CA (US)

(73) Assignee: NextNav, LLC, Santa Clara, CA (US)

(21) Appl. No.: 19/465,026

(22) Filed: Jan. 30, 2026

Related U.S. Application Data
(60) Provisional application No. 63/755,932, filed on Feb. 7, 2025.

(51) Int. Cl. G01C 25/00; G01C 5/06

(52) U.S. Cl. CPC G01C 25/00; G01C 5/06

(57) ABSTRACT

A server generates a gridded geospatial filter map that encompasses the location of a mobile device. The gridded geospatial filter map indicates a first region that is not conducive to calibrating a barometric pressure sensor of the mobile device and a second region that is conducive to calibrating the barometric pressure sensor. The first region and the second region include sub-tiles of the gridded geospatial filter map. The mobile device determines whether the location is conducive to calibrating the barometric pressure sensor based on the location being encompassed by one of the sub-tiles. When the sub-tile is in the second region, the mobile device sends to the server calibration data generated by the barometric pressure sensor, and the server calibrates the barometric pressure sensor using the calibration data. When the sub-tile is in the first region, the mobile device causes the calibration data not to be used.

### RELATED APPLICATIONS

This application claims priority to U.S. Provisional Patent Application No. 63/755,932, filed on Feb. 7, 2025, the contents of which are incorporated herein by reference in their entirety.

### BACKGROUND

Barometric-based altitude systems rely on a well-calibrated barometric pressure sensor in a consumer or user device, typically a mobile device. Under ideal conditions, the pressure sensor would already be well-calibrated and would remain so. However, most consumer-grade pressure sensors are not well-calibrated. Additionally, the calibration is prone to drift, i.e., change over time in a positive and/or negative direction. Thus, such pressure sensors have to be recalibrated from time to time using a calibration value that is derived using calibration data. The calibration data typically includes, but is not limited to, atmospheric pressure and/or temperature measurements generated using the pressure sensor to be calibrated in addition to reference pressure and temperature measurements generated by a reference system. The derived calibration value may be an offset in pressure, an offset in altitude, or a polynomial calibration equation that takes various inputs, such as temperature and/or pressure.

The calibration data needs to be reliable in order to result in a good, reliable calibration value. However, it can be difficult to determine when the calibration data is most likely to be reliable.

### SUMMARY

In some examples, a method includes: determining, by a processor of a mobile device, a location of the mobile device; transmitting the location from the mobile device to a server; generating, by one or more processors of the server, a gridded geospatial filter map of a geographical area that encompasses the location of the mobile device, wherein the gridded geospatial filter map indicates a first region that is not conducive to calibrating a barometric pressure sensor of the mobile device and a second region that is conducive to calibrating the barometric pressure sensor, the gridded geospatial filter map is a 2D grid tile, and the first region and the second region include sub-tiles of the gridded geospatial filter map; transmitting the gridded geospatial filter map from the server to the mobile device; determining, by the processor of the mobile device, whether the location is conducive to calibrating the barometric pressure sensor based on the location being encompassed by one of the sub-tiles of the gridded geospatial filter map; when the one of the sub-tiles is in the second region, the processor of the mobile device sending to the server calibration data generated by the barometric pressure sensor, and the one or more processors of the server calibrating the barometric pressure sensor using the calibration data; and when the one of the sub-tiles is in the first region, the processor of the mobile device causing the calibration data not to be used.

In some examples, a method includes: determining, by a processor of a mobile device, a location of the mobile device; transmitting the location from the mobile device to a server for the server to generate a gridded geospatial filter map of a geographical area that encompasses the location of the mobile device and to transmit the gridded geospatial filter map to the mobile device, wherein the gridded geospatial filter map indicates a first region that is not conducive to calibrating a barometric pressure sensor of the mobile device and a second region that is conducive to calibrating the barometric pressure sensor, the gridded geospatial filter map is a 2D grid tile, and the first region and the second region include sub-tiles of the gridded geospatial filter map; determining, by the processor of the mobile device, whether the location is conducive to calibrating the barometric pressure sensor based on the location being encompassed by one of the sub-tiles of the gridded geospatial filter map; when the one of the sub-tiles is in the second region, the processor of the mobile device sending to the server calibration data generated by the barometric pressure sensor for the server to calibrate the barometric pressure sensor using the calibration data; and when the one of the sub-tiles is in the first region, the processor of the mobile device causing the calibration data not to be used.

### BRIEF DESCRIPTION OF THE DRAWINGS

FIG. 1 is a simplified example environment in which a mobile device can be used, and the mobile device can determine when conditions might be conducive to calibrating a barometric pressure sensor therein, in accordance with some examples.

FIGS. 2A-2E are simplified example geospatial raster images of 2D gridded filter maps for use in determining when conditions might be conducive to calibrating a barometric pressure sensor, in accordance with some examples.

FIG. 3 shows a simplified building footprint map and a simplified example 2D building geospatial filter map generated therefrom, in accordance with some examples.

FIG. 4 is a simplified example 2D building geospatial filter map for use in generating the geospatial raster image shown in FIG. 2A, in accordance with some examples.

FIG. 5 shows graphs of a flatness metric vs a 2D location uncertainty value for different locations, in accordance with some examples.

FIGS. 6 and 7 are simplified example 2D terrain geospatial filter maps for different 2D location uncertainty values for use in generating the geospatial raster image shown in FIG. 2A, in accordance with some examples.

FIGS. 8 and 9 are simplified example 2D filter maps (combining a 2D building geospatial filter map with different 2D terrain geospatial filter maps) for different 2D location uncertainty values, in accordance with some examples.

FIG. 10 is a simplified example 2D filter map (combining the 2D building geospatial filter map of FIG. 3 with the 2D terrain geospatial filter map of FIG. 6) for use in generating the geospatial raster image shown in FIG. 2A, in accordance with some examples.

FIG. 11 is a simplified example geospatial raster image of the 2D gridded filter map shown in FIG. 2A with the 2D filter map of FIG. 10 superimposed thereon, in accordance with some examples.

FIGS. 12 and 13A-B are simplified example flowcharts of processes for determining when conditions might be conducive to calibrating the barometric pressure sensor, in accordance with some examples.

FIG. 14 is a simplified example flowchart of a process for determining when conditions might be conducive to calibrating the barometric pressure sensor, in accordance with some examples.

FIGS. 15 and 16 are simplified example flowcharts of processes for selecting an appropriate geospatial filter for use in the processes of FIGS. 12-14, in accordance with some examples.

FIG. 17 illustrates a gridded terrain geospatial filter map and a gridded building geospatial filter map with buffering for a buffered gridded building geospatial filter map, in accordance with some examples.

FIG. 18 illustrates buffering for a building footprint, in accordance with some examples.

FIG. 19 shows simplified schematic diagrams of a transmitter, a mobile device, and a server, in accordance with some examples.

### DETAILED DESCRIPTION

Calibration of a barometric pressure sensor of a mobile device (i.e., a user device or a computer device) should be done at times when the conditions under which calibration data (e.g., location and location uncertainty of the mobile device, pressure at the mobile device, and optionally temperature at the mobile device) was collected or measured are conducive to a proper or reliable calibration. The calibration value generated by the calibration process under such conditions can thereafter be applied to the pressure measurements generated by the pressure sensor so that a relatively accurate altitude can be determined from the calibrated pressure measurements generated therefrom.

In a conventional system or method, the mobile device might collect calibration data for calibration purposes on a continual or periodic basis. The mobile device sends the calibration data to a server. The server determines whether the conditions under which the calibration data was collected or measured are conducive to a proper or reliable calibration. If so, then the server uses the calibration data to perform a calibration process and sends the calibration value generated thereby to the mobile device. After receiving the calibration value, the mobile device uses the calibration value to correct pressure measurements or altitude determinations. On the other hand, if the conditions under which the calibration data was collected or measured are not conducive to a proper or reliable calibration, then the calibration data is considered unsuitable or unreliable, and the server may discard the calibration data.

A calibration data point may be unsuitable or unreliable or the conditions under which the calibration data was collected or measured may not be conducive to a proper or reliable calibration in a variety of conditions or situations. For example, such conditions or situations may include when the mobile device is inside a building or inside a multi-story building (as explained in U.S. patent Ser. Nos. 11/073,441 and 11/333,567) and/or on significantly sloped terrain (as explained in U.S. patent Ser. No. 11/555,699). (U.S. patent Ser. Nos. 11/073,441, 11/333,567 and 11/555,699 are assigned in common with the present application and incorporated by reference in their entirety herein as if fully set forth herein.)

The above-described conventional system or method of calibrating barometric pressure sensors in mobile devices involves receiving and processing large volumes of calibration data by the server. A complicating factor in this method is that much of the calibration data is of unknown quality or reliability until it is processed by the server, which means there could be a considerable amount of data that is determined not to be useful only after it has been processed by the server. This situation potentially creates a considerable data storage and processing burden on the server. However, it would cause a significant transmission and processing burden on the mobile device if the data (necessary for determining whether the conditions under which the calibration data was collected or measured are conducive to a proper or reliable calibration) were to be transmitted to the mobile device for the mobile device to determine whether to use or discard any of the calibration data.

In systems and methods of the present disclosure, the data collection method is optimized at the mobile device to reduce throughput to, and the burden on, the server without unduly increasing the transmission and processing burden on the mobile device. This optimization is done by generating and storing relatively small geospatial filter files (or maps) at a server for multiple geographical areas. In some examples, the area represented in the geospatial filter file is a projection (e.g., a 3D terrain surface projected onto a 2D horizontal surface). Additionally, the search radius is also projected onto a 2D horizontal surface for ease of searching a database.

The server transmits an appropriate geospatial filter file to the mobile device when the server receives a mobile device's location from the mobile device. The mobile device caches or stores the geospatial filter file to be used locally on the mobile device for one or more determinations of whether to use a calibration data point obtained within the geographical area of the geospatial filter.

The geospatial filter file is designed to be relatively compact or of a relatively small data size (i.e., a small computer file that uses a relatively small amount of memory or storage) for a geographical area that encompasses the location of the mobile device. Thus, the transmission of the geospatial filter file from the server to the mobile device takes relatively little bandwidth. Additionally, the use of the geospatial filter file (to determine whether the conditions under which the calibration data was collected or measured are conducive to a proper or reliable calibration) takes relatively little processing time or resources of the mobile device because the geospatial filters are optimized for efficient lookup of a location of the mobile device, i.e., optimized for storing and searching the data in the geospatial filters. In this manner, the determination of whether to use a calibration data point is offloaded to the mobile device without presenting a significant data transmission, storage, or processing burden on the mobile device. Additionally, as a consequence of using the geospatial filters described herein by the mobile device, the server is relieved of processing most or all of the calibration data points that are of unacceptable quality or reliability because the mobile device does not send such data to the server.

In some examples, the geospatial filters can be used to mask regions that are known a priori, or through field testing, to be of poor quality. In this context, “poor quality” can mean that the terrain data is inaccurate or unreliable, the localized pressure and/or temperature data is unreliable (e.g., as described in US Patent Publication No. 2023/0152490) and not accurately reflective of actual ambient pressure and temperature, or other reasons that could affect a good quality barometric sensor calibration. (US Patent Publication No. 2023/0152490 is assigned in common with the present application and incorporated by reference in its entirety as if fully set forth herein.) For example, such poor quality regions could be missing areas in a terrain database or could have areas that were badly processed and simply had to be set to a default value. In some examples, such regions could be water bodies (e.g., oceans, lakes, rivers, etc.) that are from a topographic/terrain database or another such database. In some examples, such regions could have mountains or hills that are known from a different database than a generally accepted terrain database or could be derived from a topographic dataset. In some examples, such regions may have buildings (or rows of buildings) that are missing from a building database. In some examples, such regions include buildings that are known to have artificial pressurization effects (e.g., due to a strong HVAC system, a cleanroom, a wind tunnel, etc.)

In general, the geospatial filter files are used to help to ensure that the initial estimated 2D location (i.e., latitude, longitude and uncertainty) of the mobile device is a conducive place for calibration of a barometric pressure sensor. In some examples, this generally means that the altitude of the mobile device at this location can be determined relatively unambiguously, i.e., with a high confidence or low uncertainty. Therefore, application of the geospatial filters determines whether the 2D location (e.g., latitude and longitude) of the mobile device is 1) outside of any buildings, especially multi-story buildings, and/or 2) on flat, not sloped, terrain. Thus, a building geospatial filter and a terrain (either separately or in combination) geospatial filter are used on the mobile device. Additionally, in some examples, presence of network coverage may act as a first-level geospatial filter. In such examples, the barometric sensor of a mobile device is not calibrated if the mobile device is outside of network coverage, regardless of structures in the vicinity of the mobile device or the flatness of the terrain as provided by the geospatial filters disclosed herein.

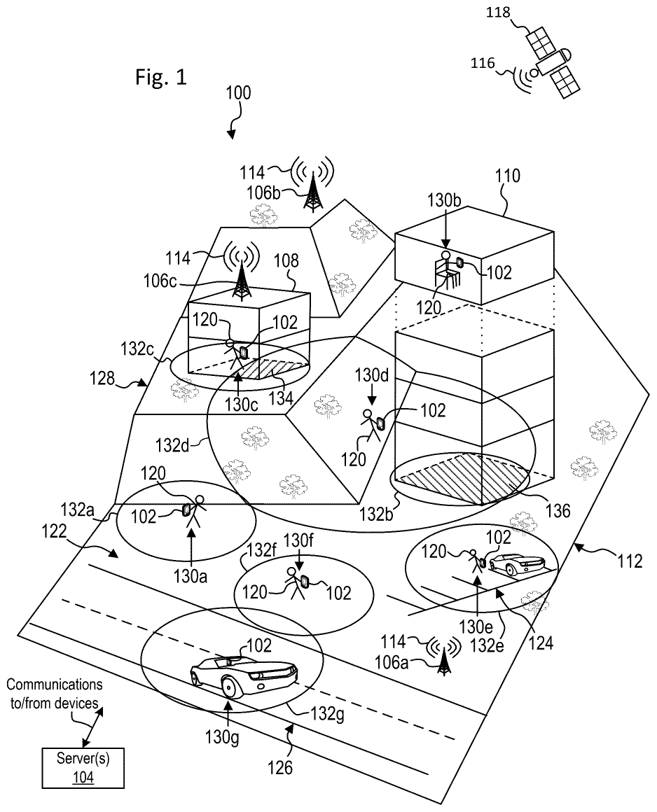

FIG. 1 is a simplified example environment 100 in which a mobile device 102 can be used, and the mobile device 102 can determine when conditions might be conducive to calibrating a barometric pressure sensor (not shown) therein, in accordance with some examples. In some examples, when the mobile device 102 determines that conditions might be conducive to calibrating its barometric pressure sensor, the mobile device 102 sends calibration data to a server(s) 104 (e.g., a cloud-based system), which performs the calibration calculations or determination.

Therefore, the environment 100 includes a network of terrestrial transmission stations (e.g., position signal transmitters and/or weather stations or reference pressure stations) 106 (106a-c), at least one of the mobile devices 102, and the system server 104. (The terrestrial transmission stations 106 represent any appropriate transmitters of signals that can be used for determining position data, such as cellular network stations, WiFi devices, a dedicated positioning network, etc.) The system server 104 exchanges communications with various devices, such as the mobile device 102. Each of the terrestrial transmission stations 106 and the mobile device 102 may be located at different altitudes or depths that are inside or outside various natural or manmade structures (e.g., first and second buildings 108 and 110, bridges, tunnels, etc.), relative to different elevations throughout a terrain 112, as illustrated by examples in FIG. 1. The first terrestrial transmission station 106a is placed within a flat area of the terrain 112; the second terrestrial transmission station 106b is placed within a hilly area of the terrain 112; and the third terrestrial transmission station 106c is placed on top of the first building 108.

Positioning signals 114 and 116 (e.g., GNSS, cellular network, WiFi, or other available signals) are transmitted from the terrestrial transmission stations 106 and from satellites 118, respectively, and are subsequently received by the mobile device 102 using known transmission technologies. For example, the terrestrial transmission stations 106 may transmit the signals 114 using one or more common multiplexing parameters that utilize time slots, pseudorandom sequences, frequency offsets, or other approaches, as is known in the art or otherwise disclosed herein. The mobile device 102 receives the positioning signals 114 and/or 116, determines its estimated location and location area (e.g., latitude, longitude, and uncertainty) based on the positioning signals 114 and/or 116, performs the processes described herein to determine whether the location is conducive to calibrating its barometric pressure sensor, and (if so) sends the location data to the server 104. Additionally, weather data (e.g., atmospheric pressure data and optionally atmospheric temperature data) is sent to or obtained by the server 104 from weather stations or a weather service. Thus, when the server 104 receives the location from the mobile device 102 and performs any further determination that it is appropriate to use this location for calibration purposes, then the server 104 can read, obtain, or calculate the relevant atmospheric pressure and optionally the atmospheric temperature for the location.

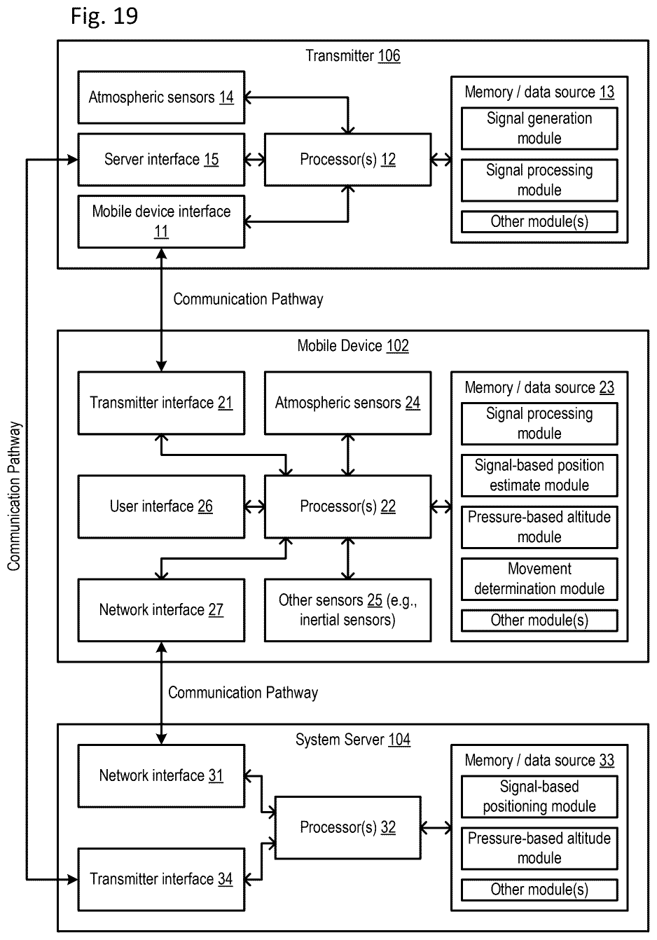

Examples of possible hardware, software and data components in the terrestrial transmission stations 106, the mobile device 102, and the system server 104 are shown in FIG. 19, as described herein. In particular, each terrestrial transmission station 106 and mobile device 102 may include atmospheric sensors (e.g., barometric pressure sensors and temperature sensors, as appropriate) for generating measurements of atmospheric conditions (e.g., atmospheric pressure and temperature) that are used to estimate an altitude of the mobile device 102 and/or to calibrate the barometric pressure sensor therein.

Several examples of the mobile device 102 are shown in FIG. 1, thereby illustrating several different situations or conditions that may be encountered by the mobile device 102 and a user 120 thereof. To illustrate these situations, the environment 100 generally includes a flat area 122, a parking lot 124 (outdoor at ground-level), a roadway 126, a hilly (or mountainous) area 128, the first building 108, and the second building 110. The terrain 112 generally includes the flat area 122, the parking lot 124, the roadway 126, and the hilly area 128. In some examples, other manmade structures such as bridges and tunnels may also be considered (e.g., included or excluded based on morphology) by geospatial filters disclosed herein in the same, or similar, way as buildings are considered.

The buildings 108 and 110 are both shown as having more than one floor (including a roof). Therefore, if the mobile device 102 is determined to be within one of the buildings 108 or 110, then it might be difficult to estimate an actual altitude of the mobile device 102 due to uncertainty with respect to which floor the mobile device 102 is on. For example, if the barometric pressure sensor of the mobile device 102 is currently not well calibrated, then a pressure measurement made by the barometric pressure sensor could result in a determination that the mobile device 102 is on the next floor above or below the actual floor that it is on. Additionally, HVAC (heating, ventilation and air conditioning) effects within the building can also render the pressure measurement unreliable, thereby distorting any altitude determination even if the barometric pressure sensor is relatively well calibrated. Consequently, conditions are considered not to be conducive to calibrating the barometric pressure sensor of the mobile device 102 for calibration data collected when the mobile device 102 is located within such a building 108 or 110.

The hilly area 128 is shown having relatively steeply sloped sections resulting in a highly variable altitude or elevation of the terrain therein. It is possible, therefore, if the user 120 and mobile device 102 were to move horizontally a short distance within the hilly area 128, then they would also move vertically by a significant amount. Additionally, because the 2D location of the mobile device 102 is usually just an estimate accompanied by some level of uncertainty, the actual 2D location of the mobile device 102 can be a significant distance away from the estimated 2D location. This uncertainty in the 2D location of the mobile device 102, therefore, can render it nearly impossible to use a terrain database to reliably associate the 2D location with a correct altitude. Consequently, conditions are considered not to be conducive to calibrating the barometric pressure sensor of the mobile device 102 for calibration data collected when the mobile device 102 is located within such a hilly area 128.

The flat area 122 is shown having a terrain with little or no variation in altitude and no structures or buildings that the user 120 and mobile device 102 could be inside of or on top of. Therefore, when the mobile device 102 is located within the flat area 122, the estimated actual altitude of the mobile device 102 can be reliably determined using a terrain database and the estimated 2D location of the mobile device 102. Additionally, pressure data measured by the barometric pressure sensor of the mobile device 102 is likely to be reliable when recorded at an outdoor location such as the flat area 122. Consequently, conditions are considered to be conducive to calibrating the barometric pressure sensor of the mobile device 102 for calibration data collected when the mobile device 102 is located within such a flat area 122.

Similarly, the parking lot 124 is shown outdoors at ground level and having a terrain with little or no variation in altitude and no structures or buildings that the user 120 and mobile device 102 could be inside of or on top of. Additionally, parking lots are commonly constructed on relatively flat land so that vehicles parked therein are not at risk of rolling away. Therefore, when the mobile device 102 is located within the parking lot 124, the estimated actual altitude of the mobile device 102 can be reliably determined using a terrain database and the estimated 2D location of the mobile device 102. Additionally, pressure data measured by the barometric pressure sensor of the mobile device 102 is likely to be reliable when recorded at an outdoor location such as the parking lot 124. Consequently, conditions are considered to be conducive to calibrating the barometric pressure sensor of the mobile device 102 for calibration data collected when the mobile device 102 is located within such a parking lot 124.

The roadway 126, on the other hand, represents an example situation in which conditions are considered not to be conducive to calibrating the barometric pressure sensor of the mobile device 102 unrelated to terrain or building considerations. For example, even if the terrain is relatively flat (as shown) and there is no building or other structure nearby, wind effects and HVAC effects can render any measurement by the barometric pressure sensor unreliable, thereby distorting any altitude determination even if the barometric pressure sensor is relatively well calibrated. Consequently, conditions are considered not to be conducive to calibrating the barometric pressure sensor of the mobile device 102 for calibration data collected when the mobile device 102 is located within such a roadway 126.

The examples of the mobile devices 102 are shown at 2D locations 130a-g in FIG. 1. (These examples are representative, but not exhaustive, of the types of situations that can be encountered.) Each 2D location 130a-g has an associated 2D location area 132a-g, respectively, that is determined based on the positioning signals 114 and/or 116 and a 2D location uncertainty for the calculated 2D location. Although each of the mobile devices 102 is shown with its 2D location 130a-g approximately at or horizontally aligned with the center of the associated 2D location area 132a-g, it is understood that, due to the uncertainty for the calculated 2D location, the mobile device 102 might actually be at any location within the 2D location area 132a-g. Although it is sometimes possible for the mobile device 102 to be outside the 2D location area, the likelihood of this is relatively low.

The user 120 with the mobile device 102 at 2D location 130a has the 2D location area 132a. The 2D location 130a is in the flat area 122 but relatively close to the edge of the hilly area 128. In this example, most of the 2D location area 132a overlaps a portion of the flat area 122 but a small portion of the 2D location area 132a overlaps a portion of the hilly area 128. In this situation, whether the altitude of the user 120 and the mobile device 102 is considered to be certain or uncertain may depend on an “overlap percentage” value in comparison to an empirically derived “overlap threshold” value.

For example, the overlap percentage value can be indicative of the percentage of the 2D location area 132a-g that overlaps a “good area” (i.e., a region that is conducive to calibrating the barometric pressure sensor, e.g., the flat area 122) vs the total 2D location area 132a-g. In this case, the overlap threshold value (acceptable percent good area vs total area) can be a minimum amount that is considered acceptable for it to be reasonably certain that the user 120 and the mobile device 102 are in a region that is good for or conducive to calibrating the barometric pressure sensor. Thus, if the overlap percentage value is greater than (or greater than or equal to) the overlap threshold value, then it may be assumed that the mobile device 102 is within the good area, and conditions may be considered to be conducive to calibrating the barometric pressure sensor of the mobile device 102 for calibration data collected at this location for the reasons described above.

On the other hand, if the overlap percentage value is less than or equal to (or less than) the overlap threshold value, then it may be assumed that the mobile device 102 is within a “bad area” (i.e., an “exclusion zone” or a region that is not conducive to calibrating the barometric pressure sensor, e.g., the hilly area 128 and/or a building footprint of one of the buildings 108 or 110), and conditions may be considered not to be conducive to calibrating the barometric pressure sensor of the mobile device 102 for calibration data collected at this location for the reasons described above.

Alternatively, the overlap percentage value can be indicative of the percentage of the respective 2D location area 132a-g that overlaps a bad area vs the total respective 2D location area 132a-g. In this case, the overlap threshold value (acceptable percent bad area vs total area) can be a maximum amount that is considered acceptable for it to be reasonably certain that the user 120 and the mobile device 102 are in the region that is conducive to calibrating the barometric pressure sensor. (This acceptable “maximum amount” can be determined empirically and may be 10%, 50%, 90%, or any other appropriate value.) Thus, if the overlap percentage value is less than (or less than or equal to) the overlap threshold value, then it may be assumed that the mobile device 102 is within the good area, and conditions may be considered to be conducive to calibrating the barometric pressure sensor of the mobile device 102 for calibration data collected at this location for the reasons described above.

On the other hand, if the overlap percentage value is greater than or equal to (or greater than) the overlap threshold value, then it may be assumed that the mobile device 102 is within the bad area, and conditions may be considered not to be conducive to calibrating the barometric pressure sensor of the mobile device 102 for calibration data collected at this location for the reasons described above.

The user 120 with the mobile device 102 at 2D location 130b has the 2D location area 132b. The 2D location 130b is within the second building 110, and the mobile device 102 is shown on the top floor thereof. The 2D location area 132b is shown at ground level since it is a two-dimensional area, i.e., without altitude, elevation or height, even if the mobile device 102 is on a higher floor (as shown). In this example, the 2D location area 132b significantly overlaps a building footprint (determined or obtained from a building database) of the second building 110 such that the building footprint overlaps most of the 2D location area 132b. (For example, comparison of the overlap percentage value with the overlap threshold value can be done to determine if the 2D location area 132b significantly overlaps the building footprint.) Thus, in this situation, it is highly likely that the user 120 and the mobile device 102 are inside the second building 110 on one of the floors thereof. Therefore, conditions are considered not to be conducive to calibrating the barometric pressure sensor of the mobile device 102 for calibration data collected at this location for the reasons described above.

The user 120 with the mobile device 102 at 2D location 130c has the 2D location area 132c. The 2D location 130c is within the first building 108, and the mobile device 102 is shown on the bottom floor thereof. In this example, the 2D location area 132c significantly overlaps a building footprint (determined or obtained from a building database) of the first building 108 such that the building footprint overlaps more than half of the 2D location area 132c. (For example, a comparison of the overlap percentage value with the overlap threshold value can be done to determine if the 2D location area 132c significantly overlaps the building footprint.) Thus, in this situation, it is uncertain whether the user 120 and the mobile device 102 are inside the first building 108 on one of the floors thereof. Due to this uncertainty, conditions are considered not to be conducive to calibrating the barometric pressure sensor of the mobile device 102 for calibration data collected at this location for the reasons described above.

The user 120 with the mobile device 102 at 2D location 130d has the 2D location area 132d. The 2D location 130d is inside the hilly area 128 near the edge thereof. In this example, the 2D location area 132d overlaps a portion of the hilly area 128, a portion of the building footprints of both buildings 108 and 110 (shaded areas 134 and 136, respectively), and a portion of the flat area 122. (For example, comparison of the overlap percentage value with the overlap threshold value can be done to determine if the 2D location area 132d significantly overlaps a combination of the hilly area 128 and the building footprints.) In this situation, therefore, the altitude of the user 120 and the mobile device 102 is relatively uncertain, because the user 120 and the mobile device 102 could be inside one of the buildings 108 or 110 (on one of the floors thereof), at a location within the hilly area 128 (which could be higher or lower than the 2D location 130d), or at a location within the flat area 122 (outside of the second building 110). Due to this uncertainty, conditions are considered not to be conducive to calibrating the barometric pressure sensor of the mobile device 102 for calibration data collected at this location for the reasons described above.

The user 120 with the mobile device 102 at 2D location 130e has the 2D location area 132e. The 2D location 130e is within the parking lot 124. In this example, the 2D location area 132e overlaps a portion of the parking lot 124 and the flat area 122, both of which are considered to be “good areas”. (For example, the overlap percentage value would be 100% if it is based on the percentage good area vs total area but would be 0% if it is based on the percentage bad area vs total area.) Therefore, conditions are considered to be conducive to calibrating the barometric pressure sensor of the mobile device 102 for calibration data collected at this location for the reasons described above.

The user 120 with the mobile device 102 at 2D location 130f has the 2D location area 132f. The 2D location 130f is within the flat area 122. In this example, the 2D location area 132f overlaps only with a portion of the flat area 122. (For example, the overlap percentage value would be 100% if it is based on the percentage good area vs total area but would be 0% if it is based on the percentage bad area vs total area.) Therefore, conditions are considered to be conducive to calibrating the barometric pressure sensor of the mobile device 102 for calibration data collected at this location for the reasons described above.

The user 120 with the mobile device 102 at 2D location 130g has the 2D location area 132g. The 2D location 130g is inside the roadway 126. (If a roadway database or a terrain database that includes roadway data does not include the widths of the roads, i.e., a road is treated as a line segment with just a starting point and an ending point, the width can be inferred based on an assumed size, a speed limit (if available), or a nearby building footprint.) In this example, the 2D location area 132g mostly overlaps a portion of the roadway 126 but also a portion of the flat area 122. (For example, comparison of the overlap percentage value with the overlap threshold value can be done to determine if the 2D location area 132g significantly overlaps the roadway 126 vs the flat area 122.) Therefore, conditions are considered not to be conducive to calibrating the barometric pressure sensor of the mobile device 102 for calibration data collected at this location for the reasons described above unrelated to terrain or building considerations.

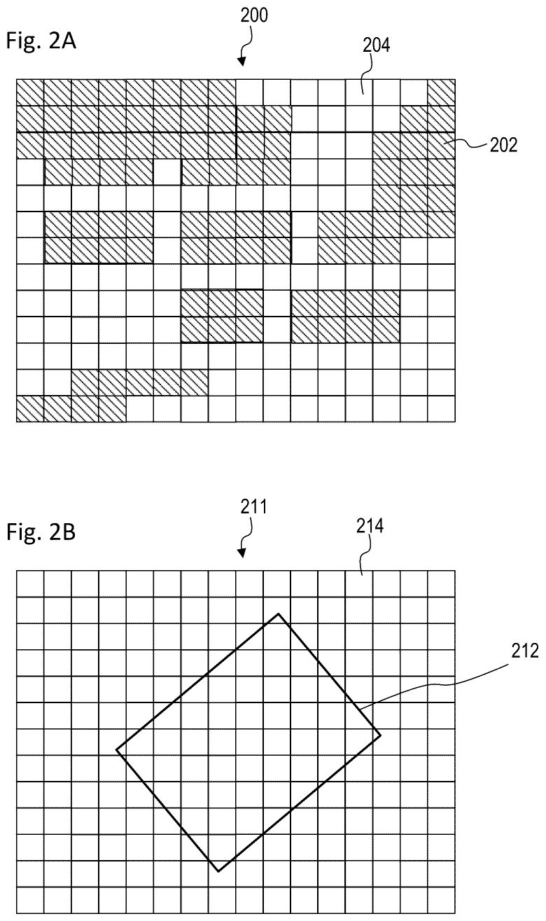

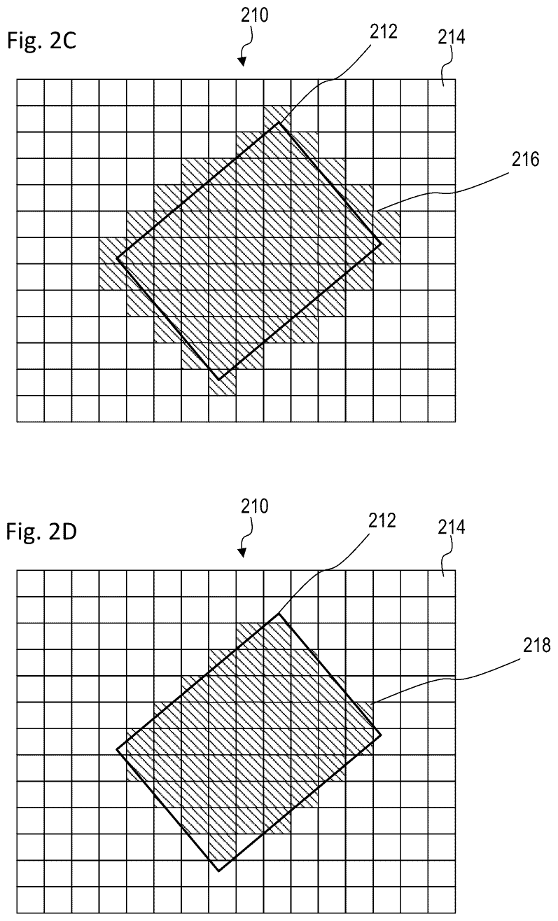

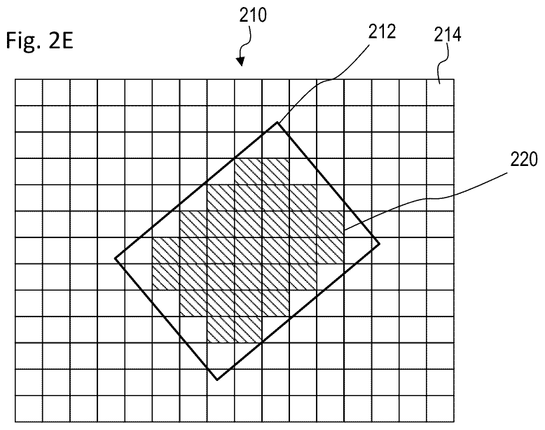

In the above-described conventional systems or methods of calibrating barometric pressure sensors in mobile devices, the server would perform a relatively high-resolution analysis of the location and location area (described above) of the mobile device to determine with a high level of precision whether the mobile device is in an area where conditions are considered to be conducive to calibrating the barometric pressure sensor. In systems and methods of the present disclosure, on the other hand, the mobile device uses the aforementioned geospatial filter file (or tile) to perform a relatively low-resolution analysis of the location and location area of the mobile device to determine whether the mobile device is in an area where conditions are considered to be conducive to calibrating the barometric pressure sensor. FIG. 2A shows an example of a gridded geospatial filter file 200 (i.e., a geospatial raster image of a 2D gridded filter map), in accordance with some examples.

The gridded geospatial filter file 200 is a 2D grid tile with shaded sub-tiles 202 and unshaded sub-tiles 204. (The tiles and sub-tiles represent data objects having predetermined sizes, locations, latitude/longitude ranges, or other geographical area descriptors. In the illustrated example, the sub-tiles 202 and 204 are shown as squares for convenience of illustration. However, the sub-tiles can be any appropriate shape, e.g., rectangle, hexagon, trapezoid, annulus section, graticule, etc., which can also vary depending on the latitude.) In some examples, the gridded geospatial filter files may have different extents in each dimension (e.g., may be wider than long, may be longer than wide, or may be equally long and wide). The dimensions may be expressed as distance, degrees, radians, arc-lengths, another measurement, or a combination of measurements. Similarly, in some examples, sub-tiles within a gridded geospatial filter file may have different extents in each dimension (e.g., may be wider than long, may be longer than wide, or may be equally long and wide). As above, the dimensions may be expressed as distance, degrees, radians, arc-lengths, another measurement, or a combination of measurements. In some examples, sub-tiles within the same gridded geospatial filter file may have different dimensions as compared with each other. For example, a first sub-tile may be 10 m by 5 m, and a closely neighboring sub-tile may be 9.5 m by 5 m.

The gridded geospatial filter file 200 represents a given geographical area such as the environment 100 shown in FIG. 1; however, the gridded geospatial filter file 200 is not intended to be a representation of the same environment 100. The shaded sub-tiles 202 indicate areas (i.e., a “first region”) within the overall geographical area that overlap (or significantly overlap) with a bad area as mentioned above (i.e., either a sloped or hilly terrain area or a building footprint). The unshaded sub-tiles 204 indicate areas (i.e., a “second region”) within the overall geographical area that overlap (or significantly overlap) with a good area as mentioned above (i.e., a region that is conducive to calibrating the barometric pressure sensor, e.g., the flat area 122).

Depending on the orientation of structures relative to the grid axes, rasterization of vector building outlines can produce visually “jagged” edges where an angled footprint is approximated by axis-aligned sub-tiles. To manage such cases, the assignment of each sub-tile as “could calibrate” or “cannot calibrate” may be determined by its areal overlap with the original building polygon. In one example (“touch-any”), if a building polygon intersects a sub-tile by any positive area, that sub-tile is marked “cannot calibrate.” This conservative setting tends to reduce false positives in data collection at the cost of potentially discarding some good data near building edges. In another example, a sub-tile is marked “cannot calibrate” only if the building overlap exceeds a threshold (e.g., 50% of the sub-tile area). In yet other examples, only sub-tiles that are fully within a building polygon are marked as “cannot calibrate”. In any such examples, a threshold policy can retain more calibrate-able coverage in dense urban environments where buildings occupy most of the map, while still screening out sub-tiles that are predominantly within structures.

FIG. 2B is a simplified example of a gridded geospatial filter file 211 in which a building footprint 212 is oriented diagonally with respect to the grid axes. Because the grid comprises axis-aligned sub-tiles 214, rasterization of an angled vector footprint can produce a visually “jagged” raster boundary.

In some examples, as shown in FIG. 2C, a first rasterization policy (i.e., a “touch-any” policy) of a gridded geospatial filter file 210 considers any sub-tile that touches the building footprint 212 as “cannot calibrate” regions, as represented by the shaded sub-tiles 216. Unshaded sub-tiles 214 are those which have no overlap with the building footprint 212. This conservative policy tends to reduce false positives in data collection near building edges by excluding all tiles touched by the structure, although it may discard some good data proximate to the boundary due to over-exclusion.

In other examples, as shown in FIG. 2D, a second rasterization policy (i.e., a “threshold policy”) of a gridded geospatial filter file 210 considers any sub-tiles that overlap the building footprint 212 by more than a specified threshold (e.g., 50%), to be “cannot calibrate” regions, as represented by the shaded sub-tiles 218. Unshaded sub-tiles 214 are those which overlap the building footprint 212 less than the specified threshold. The threshold policy can retain more calibrate-able coverage between closely spaced or angled structures in dense urban environments while still screening out tiles that are predominantly within buildings.

In yet other examples, as shown in FIG. 2E, a third rasterization policy (i.e., a “confined policy”) of a gridded geospatial filter file 210 considers only sub-tiles that are fully contained within the building footprint 212 to be “cannot calibrate” regions, as represented by the shaded sub-tiles 220. Unshaded sub-tiles 214 are those which are not within the building footprint 212. This policy maximizes the number of “could calibrate” tiles at building boundaries but may increase the risk of false positives in which calibration occurs too near a structure.

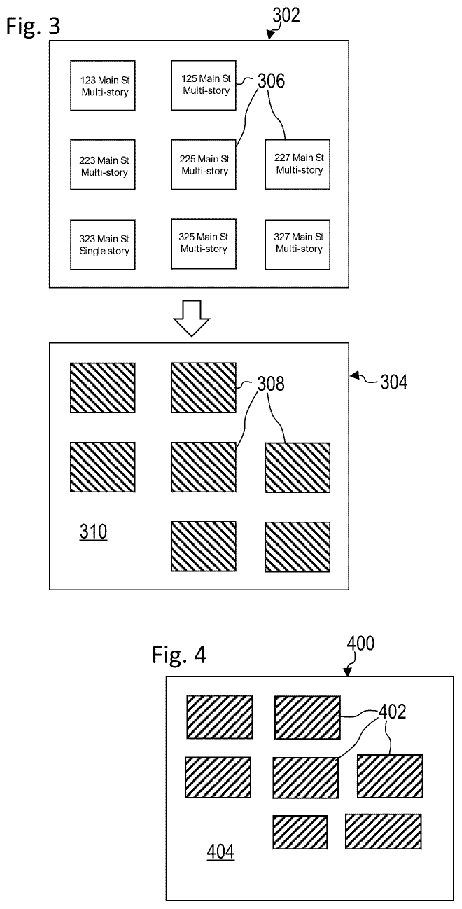

A description of an example of how to generate the gridded geospatial filter files disclosed above is provided below with respect to FIGS. 3-11.

An optimization aspect of using gridded geospatial filter maps or files is the size reduction of the geospatial filter file by conversion from a vector image to a raster image. (The term “image” is used for ease of description; however, it is understood that the images described herein are data that can potentially be displayed or converted to be displayed visually, such as a map. Such data may additionally or alternatively be stored as a data object such as a look-up-table, a database, a dictionary, a key-value pair list, and so on) Since a vector image is a collection of vertices of polygons which can be characterized as high-resolution values (e.g., floating point numbers of 32-bit resolution or higher), and the number of vertices increases considerably for complex objects, the size of such vector-based filters can be relatively large. Comparatively, raster images approximate such polygons using a gridded space (i.e., “pixels” or tiles/sub-tiles). Depending on the grid resolution of the raster images, therefore, the size of such raster-based filters is relatively smaller. In addition, calculations on a vector image are more time-consuming (i.e., to determine if a point is within a polygon could involve a more complex calculation rather than one or more pixel value lookup(s)), especially for a low-end user or mobile device. Comparatively, calculations on raster images can be a simple look-up process, such as one pixel has a logical value 0 for “cannot calibrate” (i.e., conditions are not considered to be conducive to calibrating the barometric pressure sensor) and another pixel has a logical value 1 for “Could calibrate” (i.e., conditions are considered to be conducive to calibrating the barometric pressure sensor), wherein a pixel has a given length and width that matches up to latitude and longitude range values. In some examples, the “could calibrate” designations may be assigned or labelled as “can calibrate”, such as if the server 104 does not perform any further or additional analysis to determine whether conditions are considered to be conducive to calibrating the barometric pressure sensor.

Additionally, in order to align different databases for combining building filters and terrain filters (for example), the databases are aligned to a common origin and common grid resolution. Once these are done, the combination described below with respect to FIGS. 8-11 is relatively straightforward. In addition to size reduction, a fixed-resolution raster grid may be used to enable a deterministic arithmetic index to map from latitude/longitude (and, where used, precision class) directly to a sub-tile, thereby eliminating spherical-geometry traversal and neighbor expansion. The same alignment policy may be used by both the server and mobile device so that tile identifiers remain stable across implementations and versions.

As used herein, a “precision class” (e.g., index k) is a discretized representation of the device's reported two-dimensional horizontal position uncertainty. In binned examples disclosed herein, the position uncertainty is rounded or quantized to an interval (e.g., 25 m or 50 m), and k identifies the corresponding uncertainty bin. In un-binned examples disclosed herein, k is selected by a deterministic mapping from the position uncertainty to a class boundary without hierarchical traversal. The precision class selects a corresponding geospatial filter map (e.g., terrain, building, or combined), so that the same indices (i, j) are evaluated against the uncertainty-appropriate geospatial filter map. As used herein, a precision class is distinct from measurement “accuracy”. That is, a precision class is an implementation discretization used to enable deterministic, lightweight lookups and stable, human-readable tile identifiers.

The mobile device 102 obtains the appropriate gridded geospatial filter file 200 by sending its location and/or location area to the server 104, i.e., the mobile device 102 sends a query for a region of interest in order to fetch the appropriate gridded geospatial filter file 200. The server 104 uses the location or location area to determine the gridded geospatial filter file 200 that encompasses the location or location area. In some examples, the server 104 stores previously-generated geospatial filter files, so that the server 104 performs a look-up to retrieve the appropriate geospatial filter file based on the location and/or location area received from the mobile device 102. If the location area overlaps more than one previously-generated geospatial filter file, then the server 104 may retrieve each of these geospatial filter files. The server then sends the one or more appropriate geospatial filter file to the mobile device 102. In other examples, the server 104 generates an appropriate geospatial filter file after receiving the location and/or location area such that the geospatial filter file fully encompasses the location and/or location area and optionally some additional area around the location and/or location area. The server then sends the generated appropriate geospatial filter file to the mobile device 102. The mobile device 102 then uses the received geospatial filter file to determine whether conditions are likely to be conducive to calibrating the barometric pressure sensor of the mobile device 102 for calibration data collected at this location. Furthermore, in some examples, the mobile device 102 stores the received geospatial filter file for possible future use in the event that the mobile device 102 returns to the same general area.

In some examples, the mobile device computes a tile key from (latitude, longitude, and, if applicable, precision class) and uses that key for caching and prefetch. For slow, continuous motion, the mobile device may opportunistically prefetch the immediate neighboring sub-tiles in the direction of travel to reduce future lookup latency, subject to bandwidth and storage budgets.

In some examples, the mobile device 102 applies the gridded geospatial filter file 200 by mapping (or comparing) its location and/or location area (i.e., its latitude, longitude and 2D uncertainty) to the shaded sub-tiles 202 (i.e., bad areas) and unshaded sub-tiles 204 (i.e., good areas) within the gridded geospatial filter file 200. If the mobile device 102 determines that its location is within (or maps to) one of the shaded sub-tiles 202 or that its location area overlaps or significantly overlaps any of the shaded sub-tiles 202, then the mobile device 102 determines that conditions at its location are not likely to be conducive to calibrating its barometric pressure sensor. In this case, the mobile device 102 may delete (or cause to be deleted or not used) any calibration data obtained at this location. On the other hand, if the mobile device 102 determines that its location is within one of the unshaded sub-tiles 204 (or not within one of the shaded sub-tiles 202) or that its location area overlaps or significantly overlaps with none of the shaded sub-tiles 202, then the mobile device 102 determines that conditions at its location are likely to be conducive to calibrating its barometric pressure sensor. In this case, the mobile device 102 may send the calibration data collected at this location to the server 104 for further calibration calculations or processing. (In some examples, such as if the uncertainty for the location is unavailable, then the mapping or comparing of the location is done with only a point location with no location area, e.g., just latitude and longitude with no uncertainty.)

In one implementation, the mapping is performed by computing integer grid indices (i, j) from latitude/longitude at the fixed grid resolution and, when used, selecting the precision class index k from the mobile device-reported 2D uncertainty, thereby identifying the sub-tile by (i, j, k) via arithmetic without hierarchical cell traversal or third-party geometry libraries.

The geospatial filter file (e.g., 200) is generated from a building (or structure) geospatial filter and/or a terrain geospatial filter. The building geospatial filter is generated from building data in a building footprint database and is a mask image or database that differentiates areas that are inside a building or structure versus outside a building or structure. FIG. 3 shows a simplified building footprint map 302 and a simplified example 2D building geospatial filter map 304 generated therefrom, in accordance with some examples. The building footprint map 302 is based on the building data in the building footprint database and may be a vector image (where the vertices of the shapes are stored at an appropriate resolution), or another representative data object. Thus, data for the dimensions, outlines and/or locations of footprints of buildings 306 (designated by example addresses on Main Street) are included in the building footprint database. In some examples, the building geospatial filter map 304 is a vector image which may be converted to a gridded raster image (at some resolution) and represents the building geospatial filter generated from the building data. The shaded areas 308 indicate the areas that are inside the buildings 306 (i.e., exclusion zones), and the unshaded area 310 indicates the areas that are outside the buildings 306 (or other structures). In effect, this process generates a 2D map of building footprint polygons where the insides of the building footprints (or multi-story building footprints) are unsuitable for calibration. Therefore, application of the building geospatial filter (e.g., by the server 104) can determine whether or not a location is inside or outside any of the buildings 306 or a location area overlaps or significantly overlaps any of the buildings 306.

In some examples, a location or area that maps to a single-story building is treated the same as not being in a building, because even though it is possible for the mobile device 102 to be on the roof of the building, it is typically very unlikely for this to happen. However, in other examples, a single-story building is treated the same as a multi-story building, because of the possibility (however small) of being on the roof. In some examples, a single-story building can be determined directly from a feature in a building database, determined from a number of floors feature in a building database, inferred from height of building (i.e., a building that is less than a threshold number of meters tall, such as 5 m, is likely single-story), inferred from morphology (i.e., is located in the suburbs or around other known single-story buildings), inferred from the areal footprint size (i.e., a shed or a carport footprint area would likely be <10 m² and likely single-story). One benefit to treating single-story buildings the same as situations in which a mobile device is not within a building is that the number of possible locations where a mobile device could be calibrated are expanded as compared to solutions which restrict calibration within single-story buildings.

FIG. 4 is another simplified example 2D building geospatial filter map 400 that includes shaded areas 402 (indicating building or structure footprints) and unshaded areas 404. The building geospatial filter map 400 is a vector image that represents the building geospatial filter used in generating the gridded geospatial filter file 200 shown in FIG. 2A, in accordance with some examples.

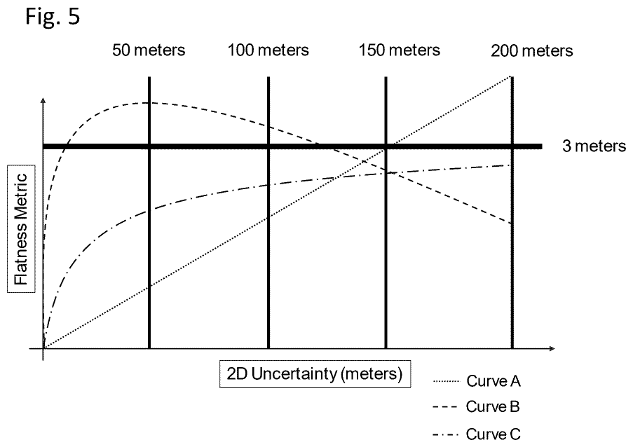

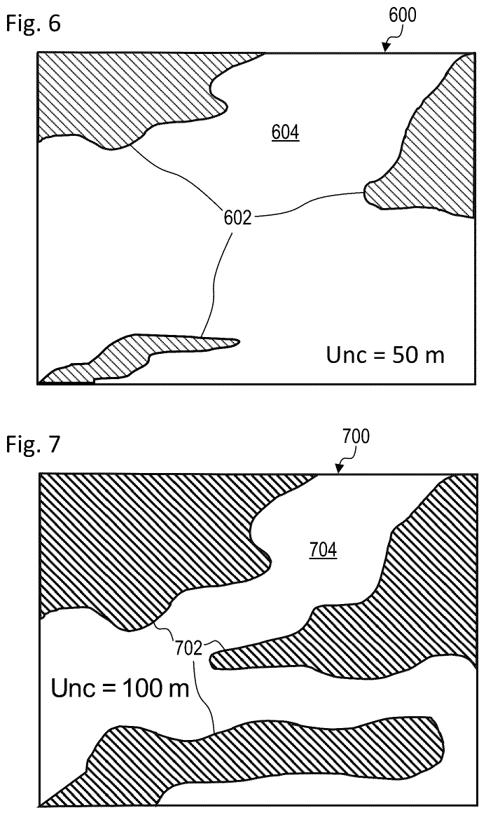

With respect to the terrain geospatial filter, FIG. 5 shows graphs of a flatness metric vs a 2D location uncertainty value for different locations, in accordance with some examples. The flatness metric generally indicates the altitude variation (e.g., a distribution of a deviation from a central altitude value) of the terrain in a given area, e.g., each of the sub-tiles 202 and 204 of the gridded geospatial filter file 200, so each sub-tile of the gridded geospatial filter file 200 has a corresponding flatness metric for the terrain within that sub-tile.

The flatness metric is used to determine whether or not the location or location area of the mobile device 102 is considered to be “flat enough” for conditions likely to be conducive to calibrating the barometric pressure sensor. A lower value for the flatness metric at a given location or location area indicates that conditions are likely to be conducive to calibrating the barometric pressure sensor, and a higher value for the flatness metric indicates that conditions are not likely to be conducive to calibrating the barometric pressure sensor. An empirically determined flatness threshold value is selected such that if the flatness metric does not exceed, or “violate”, the flatness threshold value (i.e., the flatness metric is less than or equal to (or less than) the flatness threshold value), then conditions are likely to be conducive to calibrating the barometric pressure sensor.

On the other hand, if the flatness metric exceeds, or violates, the flatness threshold value (i.e., the flatness metric is greater than (or greater than or equal to) the flatness threshold value), then conditions are not likely to be conducive to calibrating the barometric pressure sensor, because the altitude variation within the sub-tile may render any calibration value to be considered too inaccurate or have too large of an uncertainty. Thus, the flatness threshold value is empirically selected to be indicative of whether conditions are considered to be most likely to be conducive to calibrating the barometric pressure sensor.

Additionally, for each sub-tile, whether that sub-tile is one of the shaded sub-tiles 202 (i.e., is in the “first region”) or is one of the unshaded sub-tiles 204 (i.e., is in the “second region”) depends on the flatness metric for that sub-tile relative to the flatness threshold value. If more than one sub-tile 202 and/or 204 overlaps the location area of the mobile device 102, then an overall flatness threshold value may be based on the individual flatness threshold values for all of the overlapping sub-tiles. For example, if the flatness metric is less than or equal to (or less than) the flatness threshold value for a predetermined percentage of the overlapping sub-tiles, then conditions may be considered to be conducive to calibrating the barometric pressure sensor. On the other hand, if the flatness metric is greater than (or greater than or equal to) the flatness threshold value for a predetermined percentage of the overlapping sub-tiles, then conditions may be considered not to be conducive to calibrating the barometric pressure sensor.

Each sub-tile 202 and 204 is generated (i.e., shaded or unshaded) based on whether the measured/calculated flatness metric for multiple latitude and longitude combinations violates the flatness threshold value with respect to multiple possible (or allowable) location uncertainty values (i.e., possible or allowable sizes of the location areas). For example, the flatness metric can be based on the 90th percentile of the distribution of the measured altitude values with respect to a central altitude tendency value within a 2D uncertainty distance or radius from a given location (i.e., a latitude and longitude combination). This is based on terrain data in a terrain database and can result in a variation of the flatness metric across different 2D uncertainty values (e.g., 5 m to 200 m). Thus, the flatness metric for each sub-tile depends on, or corresponds to, the 2D uncertainty value for the gridded geospatial filter file.

The graphs of FIG. 5 illustrate three hypothetical flatness metric vs 2D location uncertainty value response Curves A-C. As but one example, the x-axis is labeled “2D Location Uncertainty (meters)” and the y-axis is labeled “Flatness Metric”, with an example representative flatness threshold of 3 meters. As shown, Curve A increases substantially linearly, Curve B peaks relatively quickly and then decreases, and Curve C initially grows quickly followed by growth at a slower rate.

Curve A can result, for example, from a location within a relatively slowly varying sloped area. Thus, the altitude varies relatively little within a relatively close distance to the 2D location. As the 2D uncertainty (i.e., the size of the location area) increases, however, the distribution of the measured altitude values with respect to the central altitude tendency value increases almost linearly. In this example, the flatness metric is shown to be less than or equal to the flatness threshold value of 3 m for a 2D uncertainty value that is less than or equal to about 150 m, and the flatness metric is greater than the flatness threshold value for a 2D uncertainty value that is greater than about 150 m.

Curve B can result, for example, from a location that has both a small relatively steeply sloped hill and a flat area within its location area, but as the 2D uncertainty value increases the location area encompasses more of the flat area but almost no additional hilly area. As a result in this example, the flatness metric increases rapidly at first (e.g., up to a 2D uncertainty value of about 50 m) due to the fact that the hilly area takes up a substantial percentage or portion of the location area when the location area is relatively small, so that from about the 10-meter 2D uncertainty value to about the 125-meter 2D uncertainty value the flatness metric is greater than the flatness threshold value with a peak at about the 50-meter 2D uncertainty value. As the 2D uncertainty value increases above the 50-meter 2D uncertainty value, however, the hilly area takes up a smaller percentage of the location area, and the flat area takes up a larger percentage of the location area. Thus, the net result is that the flatness metric decreases and eventually becomes less than the flatness threshold value at a point between the 100-meter and 150-meter 2D uncertainty values (e.g., about 125 m).

Curve C can result, for example, from a location near a geographical feature that extends throughout the possible uncertainty value distances but does not take up a significant portion thereof (e.g., a sharp narrow ditch, etc.). Thus, for small location areas (e.g., 2D uncertainty values less than about 50 m in this example), the flatness metric increases quickly due to the nearness of the geographical feature and the smallness of the 2D uncertainty value. However, as the 2D uncertainty value increases the flatness metric increases at a slower rate due to the geographical feature taking up a decreasing portion of the location area.

Different interpretations of the flatness metric profile in FIG. 5 can be made, each with different advantages or disadvantages. In some examples referred to as “binned”, the 2D uncertainty value is rounded to a nearest useful 2D uncertainty value (e.g., the nearest multiple of 25 m, 50 m, etc.). In some examples referred to as “unbinned”, the 2D uncertainty value is treated as a continuum, i.e., is not rounded to a nearest useful 2D uncertainty value (e.g., nearest multiple of 25 m, 50 m, etc.).

In some examples (not shown), the gridded geospatial filter data is indexed directly by (latitude, longitude) and a discretized location-precision value (“precision class”). The system defines a deterministic arithmetic mapping from the tuple (latitude, longitude, precision class) to a fixed-resolution grid, yielding integer tile indices (i, j, k), where (i, j) denote the horizontal grid coordinates and k denotes the precision class. The grid origin and per-class spatial resolution are predefined and stable so that (i, j, k) are human-interpretable and version-robust. This mapping enables device-side sub-tile selection via simple arithmetic on the reported location and uncertainty without hierarchical spherical geometry traversal or neighbor-expansion techniques, and without reliance on third-party indexing libraries (e.g., S2, H3). The stability of indexing by (i, j, k) also provides predictable cache keys that support aggressive device-side and server-side caching and efficient on-device storage.

In some implementations, the mobile device truncates the instantaneous latitude and longitude to a specified number of decimal places to identify which geospatial filter map(s) to retrieve and/or for identifying which sub-tile(s) within the retrieved geospatial filter maps correspond to the location of the mobile device. The truncation precision need not be equal in both dimensions (e.g., 4 places for latitude, 5 places for longitude). Using the truncated values, the mobile device may quickly derive integer grid coordinates (i, j) at the fixed grid resolution and select a precision class k from the reported 2D horizontal uncertainty, yielding a human-interpretable tile identifier (i, j, k) via simple arithmetic, without spherical-geometry traversal, neighbor expansion, or third-party indexing libraries. In some examples, the truncated latitude and/or longitude may be buffered by a radius derived from the 2D uncertainty. Such techniques reduce mobile device-side computational cost and implementation complexity, and, because the truncated values are human-readable, speeds debugging in field logs and telemetry.

In a first type of “unbinned” examples, if the flatness metric violates the flatness threshold value for a location with a range of possible 2D uncertainty values, then the sub-tile for that location is labeled or assigned as “cannot calibrate”, i.e., the sub-tile is shaded as for sub-tiles 202 in FIG. 2A. On the other hand, if the flatness metric does not violate the flatness threshold value in these examples, then the sub-tile is labeled or assigned as “could calibrate”, i.e., the sub-tile is unshaded as for sub-tiles 204. This approach is beneficial because it preserves uncertainties that are acceptable, and discards uncertainties that are unacceptable, for calibration. Additionally, in some “unbinned” examples, a terrain geospatial filter for the 2D uncertainty value for the location provided by the mobile device 102 can be generated by the server 104 on-the-fly upon receiving the location and uncertainty data. Furthermore, in some “unbinned” examples, the server 104 transmits to the mobile device 102 the lowest point at which the 2D uncertainty value for the location of the mobile device 102 intersects the flatness threshold value, i.e., where the curve intersects the flatness threshold value for the first time, e.g., at 150 m for Curve A or 10 m for Curve B or an indication that the curve does not intersect the flatness threshold value for Curve C.

Curve A, for this type of “unbinned” example, is valid for 2D uncertainty values less than or equal to about 150 m and is invalid at greater than about 150 m, so a sub-tile for the location of Curve A would be labeled or assigned as “could calibrate” (i.e., the sub-tile would be unshaded as for sub-tiles 204) for terrain geospatial filters for 2D uncertainty values less than or equal to about 150 m, and the sub-tile would be labeled or assigned as “cannot calibrate” (i.e., the sub-tile would be shaded as for sub-tiles 202) for terrain geospatial filters for 2D uncertainty values greater than about 150 m. As an example, therefore, the given sub-tile would be labeled or assigned as “could calibrate” in the terrain geospatial filters for 2D uncertainty values of 50 m, 100 m, and 150 m (or for the 2D uncertainty value for the mobile device's location), and the sub-tile would be labeled or assigned as “cannot calibrate” in the terrain geospatial filter for a 2D uncertainty value of 200 m. (These specific examples assume that terrain geospatial filters are not determined for 2D uncertainty values greater than 200 m or less than 50 m.)

Curve B, for this type of “unbinned” example, is valid for 2D uncertainty values less than or equal to about 10 m and greater than or equal to about 125 m and is invalid for 2D uncertainty values between about 10 m and about 125 m, so a sub-tile for the location of Curve B would be labeled or assigned as “could calibrate” (i.e., the sub-tile would be unshaded as for sub-tiles 204) for terrain geospatial filters for 2D uncertainty values less than or equal to about 10 m and greater than or equal to about 125 m, and the sub-tile would be labeled or assigned as “cannot calibrate” (i.e., the sub-tile would be shaded as for sub-tiles 202) for terrain geospatial filters for 2D uncertainty values between about 10 m and about 125 m. As an example, therefore, the given sub-tile would be labeled or assigned as “could calibrate” in the terrain geospatial filters for 2D uncertainty values of 150 m and 200 m or other appropriate values that match Curve B relative to the flatness threshold value, and the sub-tile would be labeled or assigned as “cannot calibrate” in the terrain geospatial filters for 2D uncertainty values of 50 m and 100 m or other appropriate values that match Curve B relative to the flatness threshold value.

Curve C, for this type of “unbinned” example, is valid for 2D uncertainty values less than or equal to about 200 m and is not invalid for any 2D uncertainty values (assuming terrain geospatial filters are not determined for 2D uncertainty values greater than 200 m), so a sub-tile for the location of Curve C would be labeled or assigned as “could calibrate” (i.e., the sub-tile would be unshaded as for sub-tiles 204) for terrain geospatial filters for all 2D uncertainty values. As an example, therefore, the given sub-tile would be labeled or assigned as “could calibrate” in the terrain geospatial filters for 2D uncertainty values of 50 m, 100 m, 150 m and 200 m, and the sub-tile would not be labeled or assigned as “cannot calibrate” in any of the terrain geospatial filters.

In a second type of “unbinned” examples, if the flatness metric violates the flatness threshold value for any one of the possible 2D uncertainty values for a given location, then the sub-tile for that location is labeled or assigned as “cannot calibrate”, i.e., the sub-tile is shaded as for sub-tiles 202 in FIG. 2A. On the other hand, if the flatness metric does not violate the flatness threshold value for all possible 2D uncertainty values for the location, then the sub-tile is labeled or assigned as “could calibrate”, i.e., the sub-tile is unshaded as for sub-tiles 204. This approach is beneficial if the 2D uncertainty value is considered to be relatively unreliable and/or prone to error. Thus, this approach is relatively conservative and results in discarding the calibration data for a given location if flatness metric violates the flatness threshold value under any condition. This can be beneficial in situations where the 2D location and/or 2D location area or uncertainty is considered to be relatively unstable or unreliable.

Curve A, for this type of “unbinned” example, is generally invalid for all 2D uncertainty values due to being specifically invalid for 2D uncertainty values greater than about 150 m, so a sub-tile for the location of Curve A would be labeled or assigned as “cannot calibrate” (i.e., the sub-tile would be shaded as for sub-tiles 202) for terrain geospatial filters for all 2D uncertainty values. As an example, therefore, the given sub-tile would be labeled or assigned as “cannot calibrate” in the terrain geospatial filter for a 2D uncertainty value of 50 m, 100 m, 150 m, 200 m, etc.

Curve B, for this type of “unbinned” example, is generally invalid for all 2D uncertainty values due to being specifically invalid for 2D uncertainty values between about 10 m and about 125 m, so a sub-tile for the location of Curve B would be labeled or assigned as “cannot calibrate” (i.e., the sub-tile would be shaded as for sub-tiles 202) for terrain geospatial filters for all 2D uncertainty values. As an example, therefore, the given sub-tile would be labeled or assigned as “cannot calibrate” in the terrain geospatial filter for a 2D uncertainty value of 50 m, 100 m, 150 m, 200 m, etc.

Curve C, for this type of “unbinned” example, is valid for 2D uncertainty values less than or equal to about 200 m and is not invalid for any 2D uncertainty values (assuming terrain geospatial filters are not determined for 2D uncertainty values greater than 200 m), so a sub-tile for the location of Curve C would be labeled or assigned as “could calibrate” (i.e., the sub-tile would be unshaded as for sub-tiles 204) for terrain geospatial filters for all 2D uncertainty values. As an example, therefore, the given sub-tile would be labeled or assigned as “could calibrate” in the terrain geospatial filters for 2D uncertainty values of 50 m, 100 m, 150 m and 200 m, and the sub-tile would not be labeled or assigned as “cannot calibrate” in any of the terrain geospatial filters.

In a first type of “binned” examples, if the flatness metric violates the flatness threshold value for a location that falls within a possible 2D uncertainty value “bin”, then the sub-tile for that location is labeled or assigned as “cannot calibrate”, i.e., the sub-tile is shaded as for sub-tiles 202 in FIG. 2A. On the other hand, if the flatness metric does not violate the flatness threshold value for a location that falls within a possible 2D uncertainty value “bin”, then the sub-tile is labeled or assigned as “could calibrate”, i.e., the sub-tile is unshaded as for sub-tiles 204. This approach is beneficial because it preserves uncertainties that are acceptable, and discards uncertainties that are unacceptable, for calibration.

The “bins” depend on the increments of the 2D uncertainty value for the terrain geospatial filters. For example, if the terrain geospatial filters are provided for 2D uncertainty values in 50-meter increments (i.e., for 50 m, 100 m, 150 m and 200 m), then the 2D uncertainty value for a given location is averaged or rounded to the nearest multiple of 50 meters, always rounded up to the nearest increment value, or always rounded down to the nearest increment value (except for the lowest bin). Additionally, although a value less than 25 m might normally round down to zero, a 2D uncertainty value of zero is typically not considered allowable, so values from 0 m to 25 m would be rounded up to 50 m in “binned” examples. Furthermore, although the examples shown herein use multiples of 25 or 50 meters, other values for the 2D uncertainty value can also be used, e.g., any set of individual numbers or multiples of any appropriate number. In some examples, the ranges for the bins can be non-uniform. Additionally, the bins can be designated based on a range of minimum to maximum (e.g., 0-50 m, 50-100 m, etc.), based on just the maximum (e.g., 50 m, 100 m, etc.), or based on a midpoint value (e.g., 25 m for 0-50 m, 75 m for 50-100 m, etc.).

Curve A, for this type of “binned” example, is valid for 2D uncertainty values that average or round to be less than or equal to about 150 m (e.g., 50 m, 100 m and 150 m) and is invalid at greater than about 150 m (e.g., 200 m), so a sub-tile for the location of Curve A would be labeled or assigned as “could calibrate” (i.e., the sub-tile would be unshaded as for sub-tiles 204) for terrain geospatial filters for 2D uncertainty values less than or equal to about 150 m, and the sub-tile would be labeled or assigned as “cannot calibrate” (i.e., the sub-tile would be shaded as for sub-tiles 202) for terrain geospatial filters for 2D uncertainty values greater than about 150 m. As an example, therefore, the given sub-tile would be labeled or assigned as “could calibrate” in the terrain geospatial filters for 2D uncertainty values of 50 m, 100 m and 150 m, and the sub-tile would be labeled or assigned as “cannot calibrate” in the terrain geospatial filter for a 2D uncertainty value of 200 m. (These specific examples assume that terrain geospatial filters are not determined for 2D uncertainty values greater than 200 m.)

Curve B, for this type of “binned” example, is valid for 2D uncertainty values that average or round to be greater than or equal to about 150 m (e.g., 150 m and 200 m) and is invalid for 2D uncertainty values less than about 150 m (e.g., 50 m and 100 m) (assuming the bins are at 50-meter increments), so a sub-tile for the location of Curve B would be labeled or assigned as “could calibrate” (i.e., the sub-tile would be unshaded as for sub-tiles 204) for terrain geospatial filters for 2D uncertainty values greater than or equal to about 150 m, and the sub-tile would be labeled or assigned as “cannot calibrate” (i.e., the sub-tile would be shaded as for sub-tiles 202) for terrain geospatial filters for 2D uncertainty values less than about 150 m. As an example, therefore, the given sub-tile would be labeled or assigned as “could calibrate” in the terrain geospatial filters for 2D uncertainty values of 150 m and 200 m, and the sub-tile would be labeled or assigned as “cannot calibrate” in the terrain geospatial filters for 2D uncertainty values of 50 m and 100 m. In some examples, on the other hand, if the bins are determined by always rounding up, then the “150 m” bin would be labeled or assigned as “cannot calibrate”, because a portion of its range includes a flatness metric that exceeds the flatness threshold value.

Curve C, for this type of “binned” example, is valid for 2D uncertainty values that average or round to be less than or equal to about 200 m (e.g., 50 m, 100 m, 150 m and 200 m) and is not invalid for any 2D uncertainty values (assuming the bins are at 50-meter increments and terrain geospatial filters are not determined for 2D uncertainty values greater than 200 m), so a sub-tile for the location of Curve C would be labeled or assigned as “could calibrate” (i.e., the sub-tile would be unshaded as for sub-tiles 204) for terrain geospatial filters for all 2D uncertainty values. As an example, therefore, the given sub-tile would be labeled or assigned as “could calibrate” in the terrain geospatial filters for 2D uncertainty values of 50 m, 100 m, 150 m and 200 m, and the sub-tile would not be labeled or assigned as “cannot calibrate” in any of the terrain geospatial filters.

In a second type of “binned” examples, if the flatness metric violates the flatness threshold value for any possible 2D uncertainty value “bin” for a given location, then the sub-tile for that location is labeled or assigned as “cannot calibrate”, i.e., the sub-tile is shaded as for sub-tiles 202 in FIG. 2A. On the other hand, if the flatness metric does not violate the flatness threshold value for any possible 2D uncertainty value “bin” for the location, then the sub-tile is labeled or assigned as “could calibrate”, i.e., the sub-tile is unshaded as for sub-tiles 204. This approach is beneficial if the 2D uncertainty value is considered to be relatively unreliable and/or prone to error. Thus, this approach is relatively conservative and results in discarding the calibration data for a given location if flatness metric violates the flatness threshold value under any condition.

Curve A, for this type of “binned” example, is generally invalid for all 2D uncertainty value bins due to being specifically invalid for 2D uncertainty value bins greater than about 150 m (e.g., the 200 m 2D uncertainty value bin), so a sub-tile for the location of Curve A would be labeled or assigned as “cannot calibrate” (i.e., the sub-tile would be shaded as for sub-tiles 202) for terrain geospatial filters for all 2D uncertainty value bins. As an example, therefore, the given sub-tile would be labeled or assigned as “cannot calibrate” in the terrain geospatial filter for 2D uncertainty value bins of 50 m, 100 m, 150 m, 200 m, etc.

Curve B, for this type of “binned” example, is generally invalid for all 2D uncertainty value bins due to being specifically invalid for 2D uncertainty value bins between about 10 m and about 125 m (e.g., the 50 m and 100 m 2D uncertainty value bins), so a sub-tile for the location of Curve B would be labeled or assigned as “cannot calibrate” (i.e., the sub-tile would be shaded as for sub-tiles 202) for terrain geospatial filters for all 2D uncertainty value bins. As an example, therefore, the given sub-tile would be labeled or assigned as “cannot calibrate” in the terrain geospatial filter for 2D uncertainty value bins of 50 m, 100 m, 150 m, 200 m, etc.

Curve C, for this type of “binned” example, is valid for 2D uncertainty value bins less than or equal to 200 m and is not invalid for any 2D uncertainty value bins (assuming terrain geospatial filters are not determined for 2D uncertainty value bins greater than 200 m), so a sub-tile for the location of Curve C would be labeled or assigned as “could calibrate” (i.e., the sub-tile would be unshaded as for sub-tiles 204) for terrain geospatial filters for all 2D uncertainty value bins. As an example, therefore, the given sub-tile would be labeled or assigned as “could calibrate” in the terrain geospatial filters for 2D uncertainty value bins of 50 m, 100 m, 150 m and 200 m, and the sub-tile would not be labeled or assigned as “cannot calibrate” in any of the terrain geospatial filters.

In some examples, only estimated locations of the mobile device that have less than a specified 2D uncertainty threshold (e.g., 25 m) are processed. This means that any estimated location of a mobile device having a larger uncertainty than the specified 2D uncertainty threshold would be filtered out and not processed, and estimated locations of a mobile device having a smaller uncertainty than the specified 2D uncertainty threshold would be processed according to the geospatial filters, and potentially be used for calibration. The benefit to this approach is that larger uncertainty positions, which tend to be more affected by geographic filters, are automatically removed.

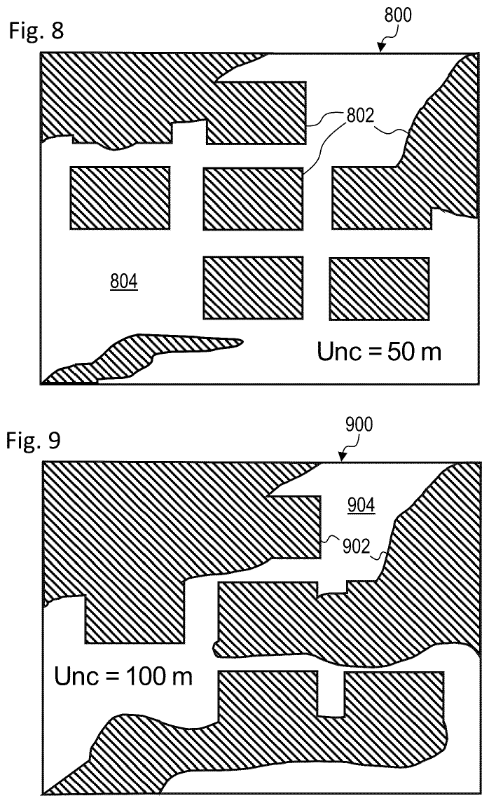

FIGS. 6 and 7 show simplified example 2D terrain geospatial filter maps 600 and 700 for different 2D location uncertainty values, in accordance with some examples. As an example, the terrain geospatial filter map 600 is used in generating the gridded geospatial filter file 200 shown in FIG. 2A.

The terrain geospatial filter map 600 is an image (i.e., an image map) example for a 2D uncertainty value (“Unc”) of 50 m for a hypothetical location. On the other hand, the terrain geospatial filter map 700 is an image example for a 2D uncertainty value of 100 m for the same hypothetical location. When generating these maps, a larger uncertainty value (for binned or unbinned examples) generally results in a larger amount of overlap with terrain areas that are considered to be “bad areas” for calibration purposes (i.e., “cannot calibrate” zones), and a smaller uncertainty value generally results in a smaller amount of overlap with terrain areas that are considered to be “bad areas”. Consequently, since the terrain geospatial filter map 600 has a lower uncertainty than that of the terrain geospatial filter map 700, the shaded areas 602 for the terrain geospatial filter map 600 are shown to be smaller than the shaded areas 702 for the terrain geospatial filter map 700 (and, similarly for the “could calibrate” zones, the unshaded areas 604 are larger than the unshaded areas 704). Thus, the shaded areas 702 for the larger uncertainty value completely overlap and extend beyond the shaded areas 602 for the smaller uncertainty values. However, the examples described above for Curve B in FIG. 5 illustrate that it is sometimes possible for a shaded area to be smaller for a larger uncertainty value (and larger for a smaller uncertainty value). In other possible examples, the shaded areas can sometimes be the same size for different uncertainty values.

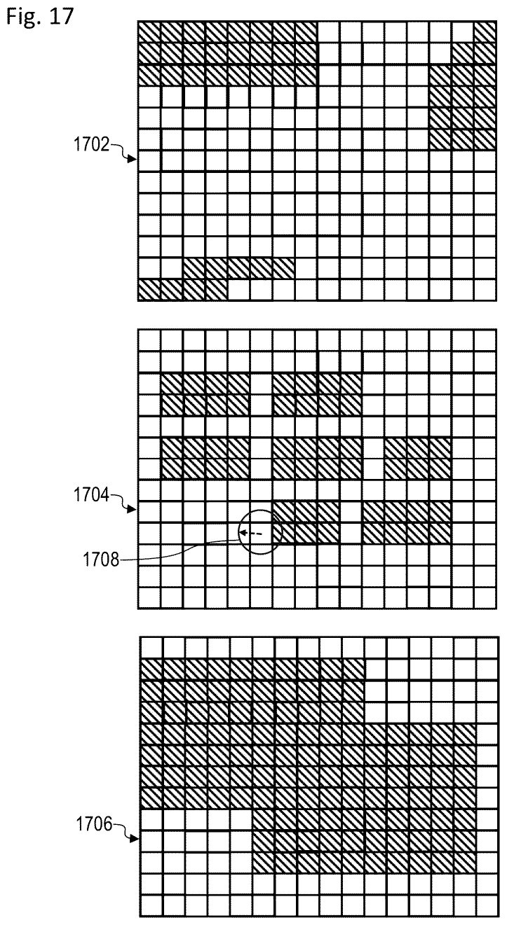

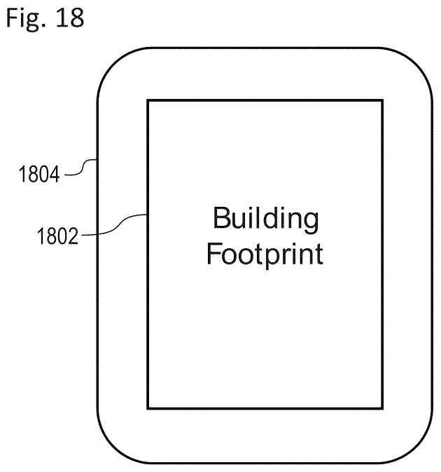

FIGS. 8 and 9 show simplified example 2D filter maps 800 and 900 in which a 2D building geospatial filter map is combined with different 2D terrain geospatial filter maps for different 2D location uncertainty values, in accordance with some examples. The terrain portion of the 2D filter map 800 is intended to correspond to the terrain geospatial filter map 600 (FIG. 6), and the terrain portion of the 2D filter map 900 is intended to correspond to the terrain geospatial filter map 700 (FIG. 7). However, the 2D building geospatial filter map used for these examples is similar to, but not intended to be the same as, the building geospatial filter map 304 (FIG. 3) or building geospatial filter map 400 (FIG. 4). In some examples, the 2D building geospatial filter map is generally the same for both uncertainty values, because the building footprints are known with a high degree of certainty, so the building footprints are not affected by the same type of “uncertainty” considerations. In some alternative examples, the building footprint polygons of the building geospatial filter map 304 or 400 could be buffered by an amount similar to a 2D uncertainty value as described below with reference to FIGS. 17 and 18. The resulting combination of the terrain geospatial filter map 600 or 700 with the example 2D building geospatial filter map produces a union of the terrain and building shaded area 802 or 902, respectively, thereby leaving the respective unshaded area 804 or 904.

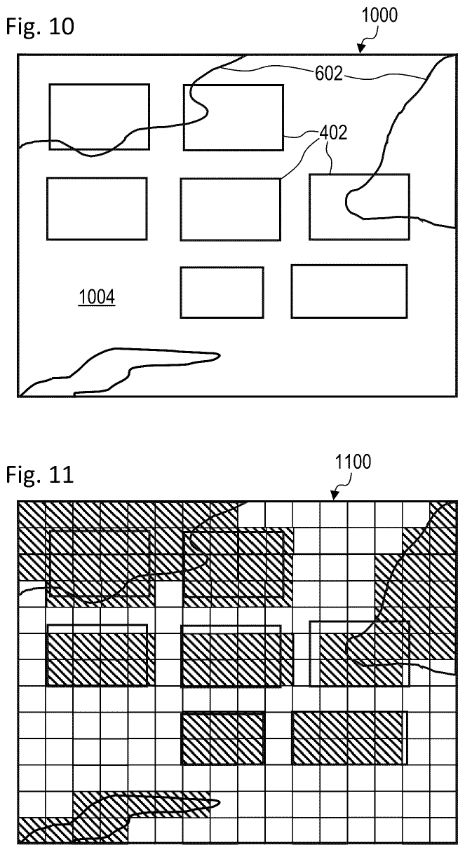

FIG. 10 shows a simplified example 2D filter map 1000 in which the building geospatial filter map 400 (FIG. 4) has been combined with the terrain geospatial filter map 600 (FIG. 6), in accordance with some examples. The 2D filter map 1000 is used to generate the geospatial raster image shown in FIG. 2A. The shading has been removed to make it easier to view the overlapping lines for the union of the shaded areas 402 of the building geospatial filter map 400 and the shaded areas 602 of the terrain geospatial filter map 600, thereby leaving the unshaded area 1004.

FIG. 11 is a simplified example of the gridded geospatial filter file 200 (FIG. 2A) with the 2D filter map 1000 (FIG. 10) superimposed thereon (i.e., combined image 1100), in accordance with some examples. This illustrates how the 2D filter map for the 50-meter uncertainty value (using the terrain geospatial filter map 600 of FIG. 6) correlates with the resulting gridded geospatial filter file for this uncertainty value. A similar gridded geospatial filter file could be generated for the 100-meter uncertainty value (using the terrain geospatial filter map 700 of FIG. 7) or for any of the other possible 2D uncertainty values or 2D uncertainty value “bins” for the same 2D location. Therefore, the gridded geospatial filter file 200 is one of multiple gridded geospatial filter maps or files that all cover the same area and encompass the location of the mobile device 102 but which correspond to multiple possible different 2D uncertainty values for the location.

The example of FIGS. 2A-11 illustrates how building geospatial filter maps and terrain geospatial filter maps can be combined so that there is one single resulting gridded geospatial filter file or map per possible 2D uncertainty value or 2D uncertainty value “bin”. This is advantageous in some cases, because it allows for only one gridded geospatial filter file to be checked with respect to a location or location area to determine whether conditions may be considered to be conducive to calibrating the barometric pressure sensor of the mobile device 102 in respect of both terrain and building issues.

Alternatively, in some examples, building geospatial filter maps and terrain geospatial filter maps can be combined such that the resulting gridded geospatial filter file corresponding to the smallest possible 2D uncertainty value or 2D uncertainty value “bin” is generated using both a building geospatial filter map, and a terrain geospatial filter map and the resulting gridded geospatial filter file corresponding to the larger (or largest) possible 2D uncertainty values or 2D uncertainty value “bins” are generated using only terrain geospatial filter maps. This is advantageous, because it allows for terrain geospatial filter maps for larger possible 2D uncertainty values or 2D uncertainty value “bins” to be of a different resolution (and hence of a smaller size) than that of the resulting gridded geospatial filter file corresponding to the smallest possible 2D uncertainty value or 2D uncertainty value “bin”. This approach also minimizes the number of files that have to be combined ahead of time.

Additionally, the example of FIGS. 2A-11 generates the gridded geospatial filter file after the vector images for the terrain geospatial filter map and the building geospatial filter map have been combined to that shown in FIGS. 8-11. However, in some alternative examples, gridded versions (e.g., of the same resolution as that of the resulting gridded geospatial filter file) of the terrain geospatial filter map and the building geospatial filter map (i.e., a gridded terrain geospatial filter map and a gridded building geospatial filter map) can be generated before the combination thereof.

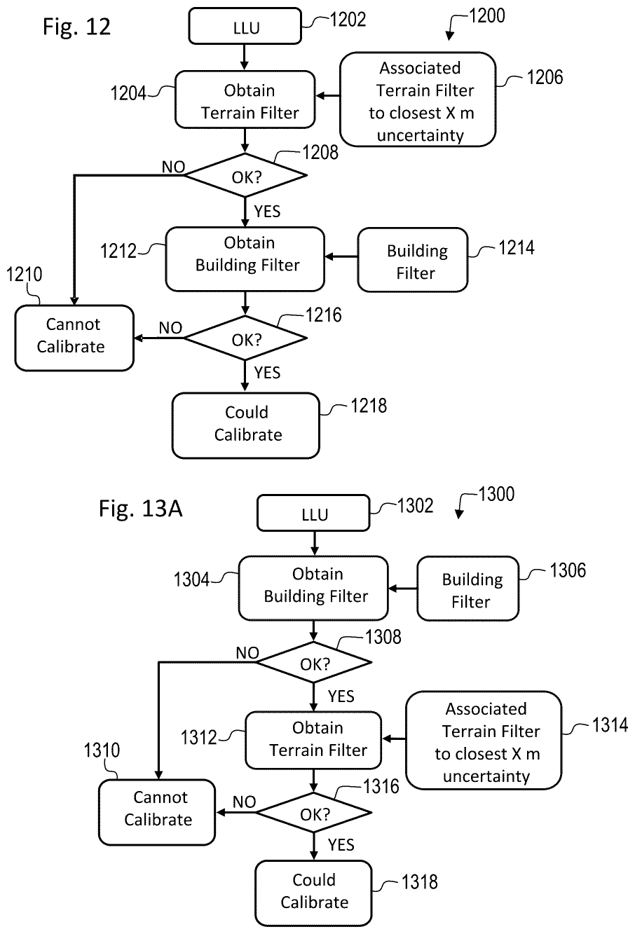

FIG. 12 is a simplified example flowchart of a process 1200 for a processor of the mobile device 102 to determine when conditions might be conducive to calibrating the barometric pressure sensor, in accordance with some examples in which a separate gridded terrain geospatial filter map is applied with the location data before a separate gridded building geospatial filter map is applied. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

Upon starting, the mobile device 102 determines or obtains (at 1202) the latitude, longitude, and 2D uncertainty (“LLU”) for its location and location area (e.g., by conventional means). Given the LLU, the mobile device 102 obtains (at 1204) from the server 104 (unless previously obtained for the same general location) the associated gridded terrain geospatial filter map 1206 for the corresponding precision class (e.g., derived from the mobile device-reported 2D uncertainty) or 2D uncertainty value “bin” (e.g., 50 m, 100 m, 150 m or 200 m) described above. As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation, as compared to that used for identifying the gridded geospatial filter map, can be used for more accurate sub-tile determination as it has greater precision than that used to resolve the gridded geospatial filter map, and enough precision to resolve the sub-tile. This is because, though a sub-tile may have a finer resolution as compared to that of a containing gridded geospatial filter map, the resolution is not infinitely fine. For example, the resolution of a given gridded geospatial filter map may be 1 km×1 km, and sub-tiles therein may have a resolution of 10 m×10 m. As such, the LLU may be truncated to a resolution of 1 km (or an equivalent geospatial projection in degrees longitude and/or latitude) for retrieving the gridded geospatial filter map, and may be truncated to a resolution of 10 m (or an equivalent geospatial projection in degrees longitude and/or latitude) for identifying sub-tiles therein.

At 1208, the mobile device 102 determines (e.g., based on the LLU and the received gridded terrain geospatial filter map 1206) whether the conditions might be conducive to calibrating the barometric pressure sensor (i.e., OK=Yes or No?) as described above. If not (i.e., OK=No), then this means that the location of the mobile device 102 is determined to match or be located in a “cannot calibrate” sub-tile in the gridded terrain geospatial filter map 1206, so the process 1200 branches to 1210 delete (or store on the mobile device and not use, summarize for a report, etc.) any collected calibration data for this location. On the other hand, if the conditions might be conducive to calibrating the barometric pressure sensor (i.e., OK=Yes at 1208), then the location is determined to match or be located in a “could calibrate” sub-tile in the gridded terrain geospatial filter map 1206. Thus, the mobile device 102 proceeds to obtain (at 1212) from the server 104 (unless previously obtained for the same general location) the gridded building geospatial filter map 1214 for the location and/or location area described above. At 1216, the mobile device 102 determines (e.g., based on the LLU and the received gridded building geospatial filter map 1214) whether the conditions might be conducive to calibrating the barometric pressure sensor (i.e., OK=Yes or No?) as described above. If not (i.e., OK=No), then this means that the location of the mobile device 102 is determined to match or be located in a “cannot calibrate” sub-tile in the gridded building geospatial filter map 1214, so the process 1200 branches to 1210 delete (or store on the mobile device and not use, summarize for a report, etc.) any collected calibration data for this location. On the other hand, if the conditions might be conducive to calibrating the barometric pressure sensor (i.e., OK=Yes at 1216), then the location is determined to match or be located in a “could calibrate” sub-tile in the gridded building geospatial filter map 1214. At this point, therefore, the location is determined to match or be located in a “could calibrate” sub-tile in both the gridded terrain geospatial filter map 1206 and the gridded building geospatial filter map 1214, so the mobile device 102 proceeds (at 1218) to follow the “could calibrate” protocol and send calibration data collected for the LLU to the server 104 for the server 104 to perform a calibration calculation (along with any additional checks on whether conditions are conducive to calibrating the barometric pressure sensor).

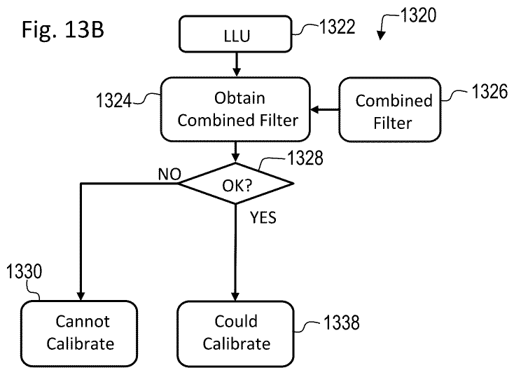

FIGS. 13A-13B provide additional example processes for determining when conditions might be conducive to calibrating the barometric pressure sensor. FIG. 13A is a simplified example flowchart of a process 1300 for a processor of the mobile device 102 to determine when conditions might be conducive to calibrating the barometric pressure sensor, in accordance with some examples in which a separate gridded building geospatial filter map is applied with the location data before a separate gridded terrain geospatial filter map is applied. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

Upon starting, the mobile device 102 determines or obtains (at 1302) the latitude, longitude, and 2D uncertainty (“LLU”) for its location and location area by conventional means. Given the LLU, the mobile device 102 obtains (at 1304) from the server 104 (unless previously obtained for the same general location) the associated gridded building geospatial filter map 1306 for the location and/or location area described above. As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation can be used for more accurate sub-tile determination as it has greater precision than that used to resolve the gridded geospatial filter map, and enough precision to resolve the sub-tile. At 1308, the mobile device 102 determines (e.g., based on the LLU and the received gridded building geospatial filter map 1306) whether the conditions might be conducive to calibrating the barometric pressure sensor (i.e., OK=Yes or No?) as described above. If not (i.e., OK=No), then this means that the location of the mobile device 102 is determined to match or be located in a “cannot calibrate” sub-tile in the gridded building geospatial filter map 1306, so the process 1300 branches to 1310 delete (or store on the mobile device and not use, summarize for a report, etc.) any collected calibration data for this location. On the other hand, if the conditions might be conducive to calibrating the barometric pressure sensor (i.e., OK=Yes at 1308), then the location is determined to match or be located in a “could calibrate” sub-tile in the gridded building geospatial filter map 1306. Thus, the mobile device 102 proceeds to obtain (at 1312) from the server 104 (unless previously obtained for the same general location) the gridded terrain geospatial filter map 1314 for the closest X meter 2D uncertainty value or 2D uncertainty value “bin” (e.g., 50 m, 100 m, 150 m or 200 m) described above. At 1316, the mobile device 102 determines (e.g., based on the LLU and the received gridded terrain geospatial filter map 1314) whether the conditions might be conducive to calibrating the barometric pressure sensor (i.e., OK=Yes or No?) as described above. If not (i.e., OK=No), then this means that the location of the mobile device 102 is determined to match or be located in a “cannot calibrate” sub-tile in the gridded terrain geospatial filter map 1314, so the process 1300 branches to 1310 delete (or store on the mobile device and not use, summarize for a report, etc.) any collected calibration data for this location. On the other hand, if the conditions might be conducive to calibrating the barometric pressure sensor (i.e., OK=Yes at 1316), then the location is determined to match or be located in a “could calibrate” sub-tile in the gridded terrain geospatial filter map 1314. At this point, therefore, the location is determined to match or be located in a “could calibrate” sub-tile in both the gridded building geospatial filter map 1306 and the gridded terrain geospatial filter map 1314, so the mobile device 102 proceeds (at 1318) to follow the “could calibrate” protocol and send calibration data collected for the LLU to the server 104 for the server 104 to perform a calibration calculation (along with any additional checks on whether conditions are conducive to calibrating the barometric pressure sensor).

FIG. 13B is a simplified example flowchart of a process 1320 for a processor of the mobile device 102 to determine when conditions might be conducive to calibrating the barometric pressure sensor, in accordance with some examples in which a combined geospatial filter (i.e., a combination of a gridded building geospatial filter map and a gridded terrain geospatial filter map) is applied. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

Upon starting, the mobile device 102 determines or obtains (at 1322) the latitude, longitude, and 2D uncertainty (“LLU”) for its location and location area by conventional means. Given the LLU, the mobile device 102 obtains (at 1324) from the server 104 (unless previously obtained for the same general location) the associated combined gridded building geospatial filter map and gridded terrain geospatial filter map 1326 for the location and/or location area and closest X meter 2D uncertainty value or 2D uncertainty value “bin” (e.g., 50 m, 100 m, 150 m or 200 m). As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation can be used for more accurate sub-tile determination as it has greater precision than that used to resolve the gridded geospatial filter map, and enough precision to resolve the sub-tile. At 1328, the mobile device 102 determines (e.g., based on the LLU and the received combined filter map 1326) whether the conditions might be conducive to calibrating the barometric pressure sensor (i.e., OK=Yes or No?) as described above. If not (i.e., OK=No), then this means that the location of the mobile device 102 is determined to match or be located in a “cannot calibrate” sub-tile in the combined filter map based on the combined gridded building geospatial filter map and gridded terrain geospatial filter map data, so the process 1320 branches to 1330 delete (or store on the mobile device and not use, summarize for a report, etc.) any collected calibration data for this location. On the other hand, if the conditions might be conducive to calibrating the barometric pressure sensor (i.e., OK=Yes at 1328), then the location is determined to match or be located in a “could calibrate” sub-tile in the combined geospatial filter map 1326, so the mobile device 102 proceeds (at 1338) to follow the “could calibrate” protocol and send calibration data collected for the LLU to the server 104 for the server 104 to perform a calibration calculation (along with any additional checks on whether conditions are conducive to calibrating the barometric pressure sensor).

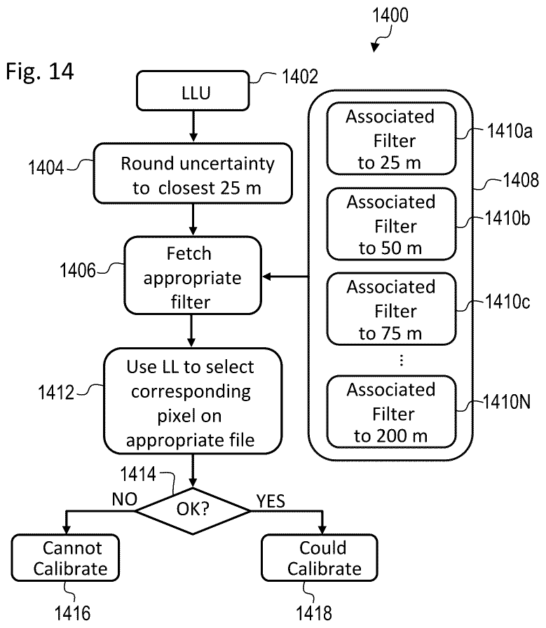

FIG. 14 is a simplified example flowchart of a process 1400 for a processor of the mobile device 102 to determine when conditions might be conducive to calibrating the barometric pressure sensor using a geospatial filter map, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

Upon starting, the mobile device 102 determines or obtains (at 1402) the latitude, longitude and 2D uncertainty (“LLU”) for its location and location area by conventional means. The mobile device 102 then rounds (at 1404) the 2D uncertainty value to the nearest X meters, which may be any appropriate uncertainty interval value. In this example, X=25 m, so the 2D uncertainty value may be rounded to a multiple of 25 between 25 m and 200 m, inclusive. Additionally, any value that would round to zero is rounded to X m instead, so the possible 2D uncertainty values (for binned or unbinned examples) are multiples of X, not including zero. Furthermore, an alternative is to always round up (never down) to the nearest X meters. As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation can be used for more accurate sub-tile determination as it has greater precision than that used to resolve the gridded geospatial filter map, and enough precision to resolve the sub-tile.

Using the rounded 2D uncertainty value, the mobile device 102 obtains or fetches (at 1406) from a filter file database 1408 via the server 104 (unless previously obtained for the same general location and uncertainty) the appropriate associated geospatial filter map 1410a-N (e.g., a gridded terrain geospatial filter map, a gridded building geospatial filter map, or a combined filter map) for the location and/or location area. In this example, the potential associated geospatial filter maps 1410a-N are shown for multiples of 25 between 25 m and 200 m, inclusive.

The mobile device 102 then uses latitude and longitude (“LL”) of the location to look up or select (at 1412) a corresponding pixel or sub-tile in the appropriate geospatial filter map. At 1414, the mobile device 102 determines whether the selected pixel or sub-tile is a “cannot calibrate” sub-tile or a “could calibrate” sub-tile (i.e., OK=No or Yes). If the selected pixel or sub-tile is a “cannot calibrate” sub-tile, then the process 1400 branches to 1416 to delete (or store on the mobile device and not use, summarize for a report, etc.) any collected calibration data for this location. If the selected pixel or sub-tile is a “could calibrate” sub-tile, then the mobile device 102 proceeds (at 1418) to follow the “could calibrate” protocol and send calibration data collected for the LLU to the server 104 for the server 104 to perform a calibration calculation (along with any additional checks on whether conditions are conducive to calibrating the barometric pressure sensor).

For the given LLU, the filter file database 1408 includes a relatively small number (e.g., 2-10) of stacked 2D images or maps, where each image corresponds to a different 2D uncertainty value bin or range (as described above). The number of ranges or bins (and bin width) can be chosen as a tradeoff of precision and file size. In this manner, the geospatial filter map for the appropriate 2D uncertainty value or 2D uncertainty value bin is selected, and then the process 1400 performs a 2D geospatial lookup to determine whether the location is in a “good area” (where conditions might be conducive to calibrating the barometric pressure sensor) or a “bad area” (where conditions might not be conducive to calibrating the barometric pressure sensor).

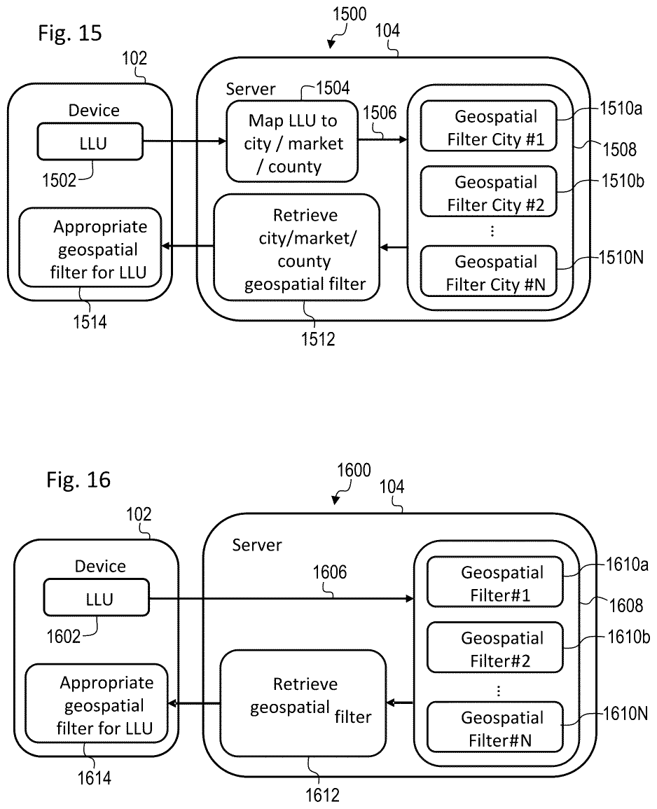

FIGS. 15 and 16 are simplified example flowcharts of processes 1500 and 1600, respectively, for selecting an appropriate geospatial filter map or file for use in the processes of FIGS. 12-14, in accordance with some examples. The particular steps, combination of steps, and order of the steps for this process are provided for illustrative purposes only. Other processes with different steps, combinations of steps, or orders of steps can also be used to achieve the same or similar result. Features or functions described for one of the steps performed by one of the components may be enabled in a different step or component in some examples. Additionally, some steps may be performed before, after or overlapping other steps, in spite of the illustrated order of the steps.

For the process 1500 (FIG. 15), the mobile device 102 determines or obtains (at 1502) the latitude, longitude and 2D uncertainty (“LLU”) for its location and location area by conventional means and transmits the LLU (i.e., sends a query) to the server 104 (unless the mobile device 102 previously obtained the geospatial filter map for the same general location and uncertainty). (The mobile device 102 or the server 104 may average or round the 2D uncertainty value to an appropriate value to match that of the geospatial filter maps for the general location.) In this example, the server 104 maps or matches (at 1504) the LLU to a city, market, county or other appropriate previously defined geographical area (e.g., using tile metadata, such as the file name), so that the division of the sub-tiles compared to the entire tile of the geospatial filter map can be done with respect to city limits, county boundaries, state boundaries, etc. As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation can be used for more accurate sub-tile determination as it has greater precision than that used to resolve the gridded geospatial filter map, and enough precision to resolve the sub-tile. Using the city, market, county, etc., the server 104 obtains or fetches (at 1506) from a filter file database 1508 the appropriate associated gridded geospatial filter map 1510a-N for the city, market, county, etc. The server 104 thus retrieves or receives (at 1512) the appropriate geospatial filter map. For example, a given location can be used to look up a particular place that is determined to be in a particular city, so the server 104 can then fetch the appropriate geospatial filter map for that city (or a relevant portion thereof). The server 104 then transmits the retrieved geospatial filter map to the mobile device 102. The mobile device 102 has thus obtained (at 1514) the appropriate geospatial filter map for the LLU, so that the mobile device 102 can use it to determine if the conditions at the LLU might be conducive to calibrating its barometric pressure sensor.

For the process 1600 (FIG. 16), the mobile device 102 determines or obtains (at 1602) the latitude, longitude and 2D uncertainty (“LLU”) for its location and location area (e.g., by conventional means) and transmits the LLU or truncated/buffered LLU (i.e., sends a query) (at 1606) to the server 104 (unless the mobile device 102 previously obtained the geospatial filter map for the same general location and uncertainty). (The mobile device 102 or the server 104 may average or round the 2D uncertainty value to an appropriate value to match that of the geospatial filter maps for the general location.) In this example, the server 104 does not map the LLU to a city, market, county, or other appropriate previously defined geographical area. Instead, the server 104 uses the LLU to obtain or fetch (at 1612) from a filter file database 1608 the appropriate associated gridded geospatial filter map 1610a-N that directly maps to the LLU (i.e., the location and/or location area) received from the mobile device 102. The server 104 thus retrieves or receives (at 1612) the appropriate geospatial filter map. This example has an advantage of not needing to read tile metadata for the city, market, county, etc. prior to selection of the geospatial filter map. For example, a given latitude, longitude, and uncertainty can be used to look up or match a database file structure with a latitude range and a longitude range, so the server 104 can then fetch the appropriate geospatial filter map for the latitude and longitude ranges that encompass the latitude and longitude of the location and/or location area. As described above, a truncated representation of the latitude and/or longitude may be used for determining which geospatial filter map(s) to retrieve, as well as determining which sub-tile(s) of the geospatial filter map corresponds to the LLU. In another example, a non-truncated representation can be used for more accurate sub-tile determination as it has more precision than the truncated one. In another example, a less truncated representation can be used for more accurate sub-tile determination as it has greater precision than that used to resolve the gridded geospatial filter map, and enough precision to resolve the sub-tile. The server 104 then transmits the retrieved geospatial filter map to the mobile device 102. The mobile device 102 has thus obtained (at 1614) the appropriate geospatial filter map for the LLU, so that the mobile device 102 can use it to determine if the conditions at the LLU might be conducive to calibrating its barometric pressure sensor.

In some examples, instead of using a combined gridded geospatial filter file as described above with respect to FIGS. 2A-11, the determination of whether conditions may be considered to be conducive to calibrating the barometric pressure sensor can be done with separate gridded terrain geospatial filter maps and gridded building geospatial filter maps (i.e., the gridded geospatial filter map is considered to comprise the gridded building geospatial filter map and the gridded terrain geospatial filter map) as described with reference to FIG. 12 or 13. Thus, the two types of gridded filter maps can be applied or used separately in any desired order to determine whether the location or location area is conducive to calibrating the barometric pressure sensor based on either the gridded building geospatial filter map or the gridded terrain geospatial filter map. An advantage of applying the two types of gridded filter maps separately is that the resolutions of the two maps can be different. For example, the gridded terrain geospatial filter map can be coarser than the gridded building geospatial filter map, thereby allowing for a reduction in the size of the gridded terrain geospatial filter map. In addition, if one of the types of gridded filter maps is more restrictive than the other, then the more restrictive one can be run first, potentially eliminating the need to run the other, thereby reducing the overall processing time.

Another advantage of applying the two types of gridded filter maps separately is in the search methodology. For example, the gridded building geospatial filter map can be checked against a 2D location (e.g., with latitude, longitude and uncertainty) and the gridded terrain geospatial filter map can be checked against a point location (e.g., with latitude and longitude), because the gridded terrain geospatial filter map already has the concept of uncertainty “built in”.

FIG. 17 illustrates a gridded terrain geospatial filter map and a gridded building geospatial filter map with buffering for a buffered gridded building geospatial filter map, in accordance with some examples. FIG. 18 illustrates buffering for a building footprint, in accordance with some examples.

The gridded terrain geospatial filter map 1702 is generated from a 2D terrain geospatial filter map of a given 2D uncertainty value, e.g., similar to but not exactly the same as the example 2D terrain geospatial filter map 600 in FIG. 6. Thus, the gridded terrain geospatial filter map 1702 can be applied (independently of and in addition to a gridded building geospatial filter) for a corresponding 2D uncertainty value for the location of the mobile device 102 to determine whether or not the location or location area of the mobile device 102 is considered to be “flat enough” for conditions likely to be conducive to calibrating the barometric pressure sensor.

The gridded building geospatial filter map 1704 is generated from a building footprint map, e.g., similar to the descriptions of FIGS. 3 and 4. Additionally, a circle 1708 (for a 2D location area) is shown surrounding a location to illustrate a circular lookup in which a radius (arrow) of the circle 1708 corresponds to a 2D location uncertainty, such that if the 2D location area overlaps with a “bad area” (where conditions might not be conducive to calibrating the barometric pressure sensor, e.g., the shaded sub-tiles), then the location (or the sub-tile it is in) is assigned or labelled as “cannot calibrate”. In some examples, the mobile device 102 determines whether the amount of the overlap of the circle 1708 with “bad area” exceeds an overlap threshold a) by any amount of overlap, b) by a predetermined percentage overlap (e.g., 20%, 50%, 90%, etc.), or c) by a specific area overlap (e.g., 2, 5, 10, etc. square meters); and if the overlap threshold is exceeded, then the 2D location or the sub-tile containing the 2D location is assigned or labeled as a “bad area”. Thus, the gridded building geospatial filter map 1704 can be applied (independently of and in addition to a gridded terrain geospatial filter) for a corresponding 2D uncertainty value for the location of the mobile device 102 to determine whether or not the location or location area of the mobile device 102 is close enough to a building for it to be considered sufficiently likely that the mobile device 102 might be inside the building, so conditions are likely not to be conducive to calibrating the barometric pressure sensor.

The buffered gridded building geospatial filter map 1706 is generated from a building footprint map, e.g., similar to the gridded building geospatial filter map 1704. However, the building footprints are buffered by an appropriate amount corresponding to a 2D location uncertainty. In this example, the buffer extends one sub-tile in every direction around the “buildings” of the gridded building geospatial filter map 1704. FIG. 18 illustrates an example building footprint 1802 with a buffer 1804 surrounding it, which can be used to generate the buffered gridded building geospatial filter map 1706. Thus, the buffered gridded building geospatial filter map 1706 can be applied (independently of and in addition to a gridded terrain geospatial filter) in a sub-tile lookup process for the location of the mobile device 102 to determine whether or not the location of the mobile device 102 is close enough to a building for it to be considered sufficiently likely that the mobile device 102 might be inside the building, so conditions are likely not to be conducive to calibrating the barometric pressure sensor. Buffering the building footprints by an appropriate buffer amount can align the search method for combining a gridded building geospatial filter map with a gridded terrain geospatial filter map, but this technique could “lock in” a particular uncertainty level.

For the server 104 to perform a calibration calculation, an altitude of the mobile device 102 is calculated above a given reference plane via the known barometric formula:

$${h}_{device} = {h}_{reference} \frac{{RT}_{ambient}}{gM} ln ( \frac{{P}_{ambient}}{{P}_{device}} )$$

where R, g and M are all known constants, P_{ambient} is the ambient pressure (typically provided from a reference network such as a nearby weather station in a weather station network), T_{ambient} is the ambient temperature (typically also provided from the reference network), P_{device} is the mobile device pressure as measured by the mobile device's onboard barometric pressure sensor, and h_{reference} is the height of the reference plane (e.g., sea-level, 0 m Height Above Ellipsoid, etc). In order to calibrate P_{device}, its value is measured at known altitudes, and a calibration value is determined that can be used to adjust the measured pressure by some amount so that the calculated altitude matches the known altitude. In order to determine or compute the correct altitude that h_{device} should be, the corresponding location of the mobile device 102 (usually sourced from the 2D position of the mobile device through some location engine like GPS or WiFi) is used with the geospatial filter maps as described above, so that the determined altitude is not considered ambiguous, e.g., not located within a multi-story building or on a sloped region where altitude changes abruptly for a small 2D deviation. The quality of the calibration data generated at a location is unknown until cross-checked against the geospatial filter map from the database to see if conditions at the location are conducive to calibration. This determination process is conventionally done by hosting these databases on the server and querying a location from the mobile device to the server, but this approach requires the server to maintain the databases and increases traffic between the mobile device and the server. Thus, the above-described systems and methods have been developed.

By way of example in FIG. 19, the terrestrial transmission stations 106 (“Transmitter”) discussed herein may include: a mobile device interface 11 for exchanging information with the mobile device 102 (e.g., antenna(s) and RF front end components known in the art or otherwise disclosed herein); one or more computer processor(s) 12; a memory/data source 13 for providing storage and retrieval of information and/or program instructions; atmospheric sensor(s) 14 for measuring environmental or weather conditions (e.g., pressure, temperature, humidity, etc.) at or near the terrestrial transmission station 106; a server interface 15 for exchanging information with a system server 104 (e.g., an antenna, a wired or wireless network interface, etc.); and any other components known to one of ordinary skill in the art. The memory/data source 13 may include memory storing software modules with executable instructions, and the computer processor(s) 12 may perform different actions by executing the instructions from the modules, including: (i) performance of part or all of the methods or processes as described herein or otherwise understood by one of skill in the art as being performable at the terrestrial transmission station 106; (ii) generation of positioning signals for transmission using a selected time, frequency, code, and/or phase; (iii) processing of signaling received from the mobile device 102, the server 104 or other source; (iv) generation or measurement of pressure, temperature, humidity, etc.; or (v) other processing as required by operations described in this disclosure. Signals 114 generated and transmitted by the terrestrial transmission station 106 may carry different information that, once determined by the mobile device 102 or the server 104, may identify the following: the terrestrial transmission station 106; the terrestrial transmission station's position; environmental or weather conditions at or near the terrestrial transmission station 106; and/or other information known in the art. The atmospheric sensor(s) 14 may be integral with the terrestrial transmission station 106, or separate from the terrestrial transmission station 106 and either co-located with the terrestrial transmission station 106 or located in the vicinity of the terrestrial transmission station 106 (e.g., within a threshold amount of distance).

By way of example in FIG. 19, the mobile (or user) device 102 may include a network interface 27 for exchanging information with the server 104 via a network (e.g., a wired and/or a wireless interface port, an antenna and RF front end components known in the art or otherwise disclosed herein); one or more computer processor(s) 22; memory/data source 23 for providing storage and retrieval of information and/or program instructions; atmospheric sensor(s) 24 (including the barometric pressure sensor) for measuring environmental conditions (e.g., pressure, temperature, other) at the mobile device 102; other sensor(s) 25 for measuring other conditions (e.g., compass, accelerometer and inertial sensors for measuring movement and orientation); a user interface 26 (e.g., display, keyboard, microphone, speaker, etc.) for permitting the mobile device 102 to receive inputs from and provide outputs to a user; and any other components known to one of ordinary skill in the art. A GNSS interface and processing unit (not shown) are contemplated, which may be integrated with other components or a standalone antenna, RF front end, and computer processors dedicated to receiving and processing GNSS signaling. The memory/data source 23 may include memory storing data and software modules with executable instructions, including a signal processing module, a signal-based position estimate module, a pressure-based altitude module, a movement determination module, the current calibration value, data packets sent to or from the server 104, a calibration module, and other modules. The computer processor(s) 22 may perform different actions by executing the instructions from the modules, including: (i) performance of part or all of the methods, processes and techniques as described herein or otherwise understood by one of ordinary skill in the art as being performable at the mobile device 102; (ii) estimation of an altitude of the mobile device 102 (based on measurements of pressure from the mobile device 102 and terrestrial transmission station(s) 106, temperature measurement(s) from the terrestrial transmission station(s) 106 or another source, and any other information needed for the computation); (iii) processing of received signals to determine position information, location data, or calibration data (e.g., times of arrival or travel time of the signals, pseudoranges between the mobile device 102 and positioning transmitters, terrestrial transmission station atmospheric/weather conditions, terrestrial transmission station and/or locations or other terrestrial transmission station information); (iv) use of position information to compute an estimated position of the mobile device 102; (v) determination of movement based on measurements from inertial sensors of the mobile device 102; (vi) GNSS signal processing; (vii) assembling and transmitting data packets; (viii) storing a current calibration value and data packets; (ix) calibrating the barometric pressure sensor; (x) collecting calibration data; (xi) determining whether conditions might be conducive to calibrating the barometric pressure sensor; and/or (xii) other processing as required by operations described in this disclosure.

By way of example in FIG. 19, the server 104 may include: a network interface 31 for exchanging information with the mobile device 102 and other sources of data via a network (e.g., a wired and/or a wireless interface port, an antenna, or other); one or more computer processor(s) 32; memory/data source 33 for providing storage and retrieval of information and/or program instructions; and any other components known to one of ordinary skill in the art. The memory/data source 33 may include memory storing software modules with executable instructions, such as geospatial filter selection modules, calibration technique modules, a signal-based positioning module, a pressure-based altitude module, a calibration conduciveness module, as well as other modules for each of the above-described methods and processes or portions/steps thereof. The computer processor(s) 32 may perform different actions by executing instructions from the modules, including: (i) performance of part or all of the methods, processes and techniques as described herein or otherwise understood by one of ordinary skill in the art as being performable at the server 104; (ii) estimation of an altitude of the mobile device 102; (iii) computation of an estimated position of the mobile device 102; (iv) performance of calibration techniques; (v) calibration of the mobile device 102; (vi) determination of calibration conduciveness for a calibration opportunity; (vii) storage and selection of a geospatial filter map; or (viii) other processing as required by operations or processes described in this disclosure. Steps performed by servers 104 as described herein may also be performed on other machines that are remote from the mobile device 102, including computers of enterprises or any other suitable machine.

Reference has been made in detail to examples of the disclosed invention, one or more examples of which have been illustrated in the accompanying figures. Each example has been provided by way of explanation of the present technology, not as a limitation of the present technology. In fact, while the specification has been described in detail with respect to specific examples of the invention, it will be appreciated that those skilled in the art, upon attaining an understanding of the foregoing, may readily conceive of alterations to, variations of, and equivalents to these examples. For instance, features illustrated or described as part of one example may be used with another example to yield a still further example. Thus, it is intended that the present subject matter covers all such modifications and variations within the scope of the appended claims and their equivalents. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A method comprising:
determining, by a processor of a mobile device, a location of the mobile device;
transmitting the location from the mobile device to a server;
generating, by one or more processors of the server, a gridded geospatial filter map of a geographical area that encompasses the location of the mobile device, wherein the gridded geospatial filter map indicates a first region that is not conducive to calibrating a barometric pressure sensor of the mobile device and a second region that is conducive to calibrating the barometric pressure sensor, the gridded geospatial filter map is a 2D grid tile, and the first region and the second region include sub-tiles of the gridded geospatial filter map;
transmitting the gridded geospatial filter map from the server to the mobile device;
determining, by the processor of the mobile device, whether the location is conducive to calibrating the barometric pressure sensor based on the location being encompassed by one of the sub-tiles of the gridded geospatial filter map;
when the one of the sub-tiles is in the second region, the processor of the mobile device sending to the server calibration data generated by the barometric pressure sensor, and the one or more processors of the server calibrating the barometric pressure sensor using the calibration data; and
when the one of the sub-tiles is in the first region, the processor of the mobile device causing the calibration data not to be used.

2. The method of claim 1, wherein:
the gridded geospatial filter map is one of a plurality of gridded geospatial filter maps for the geographical area that encompasses the location of the mobile device; and
each of the plurality of gridded geospatial filter maps corresponds to one of a plurality of possible uncertainty values for the location of the mobile device.

3. The method of claim 2, wherein:
each of the plurality of possible uncertainty values is a multiple of an uncertainty interval value.

4. The method of claim 3, wherein:
the uncertainty interval value is 25 meters; and
the plurality of possible uncertainty values is between 25 meters and 200 meters inclusive.

5. The method of claim 3, wherein:
the uncertainty interval value is 50 meters; and
the plurality of possible uncertainty values is between 50 meters and 200 meters inclusive.

6. The method of claim 2, wherein:
each sub-tile of the gridded geospatial filter map has a flatness metric for a terrain within that sub-tile, the flatness metric depending on the uncertainty value that corresponds to the gridded geospatial filter map; and
for each sub-tile, whether that sub-tile is in the first region or the second region depends on the flatness metric for that sub-tile relative to a flatness threshold value.

7. The method of claim 6, wherein:
for each sub-tile, the sub-tile is in the first region if the flatness metric for the uncertainty value that corresponds to the gridded geospatial filter map exceeds the flatness threshold value, and the sub-tile is in the second region if the flatness metric for the uncertainty value that corresponds to the gridded geospatial filter map does not exceed the flatness threshold value.

8. The method of claim 6, wherein:
for each sub-tile, the sub-tile is in the first region if the flatness metric exceeds the flatness threshold value for any of the plurality of possible uncertainty values, and the sub-tile is in the second region if the flatness metric does not exceed the flatness threshold value for all of the plurality of possible uncertainty values.

9. The method of claim 1, wherein:
the gridded geospatial filter map is a single map based on a combination of a building geospatial filter map and a terrain geospatial filter map.

10. The method of claim 1, wherein:
the gridded geospatial filter map comprises a gridded building geospatial filter map and a gridded terrain geospatial filter map; and
the gridded building geospatial filter map and the gridded terrain geospatial filter map are used separately to determine whether the location is conducive to calibrating the barometric pressure sensor based on the location being encompassed by one of the sub-tiles of the gridded building geospatial filter map or the gridded terrain geospatial filter map.

11. A method comprising:
determining, by a processor of a mobile device, a location of the mobile device;
transmitting the location from the mobile device to a server for the server to generate a gridded geospatial filter map of a geographical area that encompasses the location of the mobile device and to transmit the gridded geospatial filter map to the mobile device, wherein the gridded geospatial filter map indicates a first region that is not conducive to calibrating a barometric pressure sensor of the mobile device and a second region that is conducive to calibrating the barometric pressure sensor, the gridded geospatial filter map is a 2D grid tile, and the first region and the second region include sub-tiles of the gridded geospatial filter map;
determining, by the processor of the mobile device, whether the location is conducive to calibrating the barometric pressure sensor based on the location being encompassed by one of the sub-tiles of the gridded geospatial filter map;
when the one of the sub-tiles is in the second region, the processor of the mobile device sending to the server calibration data generated by the barometric pressure sensor for the server to calibrate the barometric pressure sensor using the calibration data; and
when the one of the sub-tiles is in the first region, the processor of the mobile device causing the calibration data not to be used.

12. The method of claim 11, wherein:
the gridded geospatial filter map is one of a plurality of gridded geospatial filter maps for the geographical area that encompasses the location of the mobile device; and
each of the plurality of gridded geospatial filter maps corresponds to one of a plurality of possible uncertainty values for the location of the mobile device.

13. The method of claim 12, wherein:
each of the plurality of possible uncertainty values is a multiple of an uncertainty interval value.

14. The method of claim 13, wherein:
the uncertainty interval value is 25 meters; and
the plurality of possible uncertainty values is between 25 meters and 200 meters inclusive.

15. The method of claim 13, wherein:
the uncertainty interval value is 50 meters; and
the plurality of possible uncertainty values is between 50 meters and 200 meters inclusive.

16. The method of claim 12, wherein:
each sub-tile of the gridded geospatial filter map has a flatness metric for a terrain within that sub-tile, the flatness metric depending on the uncertainty value that corresponds to the gridded geospatial filter map; and
for each sub-tile, whether that sub-tile is in the first region or the second region depends on the flatness metric for that sub-tile relative to a flatness threshold value.

17. The method of claim 16, wherein:
for each sub-tile, the sub-tile is in the first region if the flatness metric for the uncertainty value that corresponds to the gridded geospatial filter map exceeds the flatness threshold value, and the sub-tile is in the second region if the flatness metric for the uncertainty value that corresponds to the gridded geospatial filter map does not exceed the flatness threshold value.

18. The method of claim 16, wherein:
for each sub-tile, the sub-tile is in the first region if the flatness metric exceeds the flatness threshold value for any of the plurality of possible uncertainty values, and the sub-tile is in the second region if the flatness metric does not exceed the flatness threshold value for all of the plurality of possible uncertainty values.

19. The method of claim 11, wherein:
the gridded geospatial filter map is a single map based on a combination of a building geospatial filter map and a terrain geospatial filter map.

20. The method of claim 11, wherein:
the gridded geospatial filter map comprises a gridded building geospatial filter map and a gridded terrain geospatial filter map; and
the gridded building geospatial filter map and the gridded terrain geospatial filter map are used separately to determine whether the location is conducive to calibrating the barometric pressure sensor based on the location being encompassed by one of the sub-tiles of the gridded building geospatial filter map or the gridded terrain geospatial filter map.
